(19) United States
(12) Patent Application Publication
(10) Pub. No.: US 2025/0222852 A1
(43) Pub. Date: Jul. 10, 2025

(54) RATCHETING WEB RETRACTOR WITH RELEASABLE WEB TENSION LIMITER

(71) Applicant: INDIANA MILLS & MANUFACTURING, INC., Westfield, IN (US)

(72) Inventors: Matthew Grubbs FARRAR, V, Westfield, IN (US); Nathan Andrew BEADLE, Westfield, IN (US); Jeffrey A. KING, Markleville, IN (US)

(21) Appl. No.: 18/850,854

(22) PCT Filed: Mar. 20, 2023
(86) PCT No.: PCT/US2023/015619

§ 371 Date: Sep. 25, 2024

Related U.S. Application Data
(60) Provisional application No. 63/324,778, filed on Mar. 29, 2022.
(60) Provisional application No. 63/356,159, filed on Jun. 28, 2022.

(51) Int. Cl. B60P 7/08

(52) U.S. Cl. CPC B60P 7/083

(57) ABSTRACT

A web retractor may include a frame including spaced-apart side walls, a spool rotatably mounted to and between the side walls, a web having one end mounted to the spool, the spool rotatable relative to the side walls in a web take-up direction to wrap the web onto the spool and in a web pay-out direction to unwrap the web from the spool, a handle movably mounted to the side walls and engageable with the spool such that, with the handle engaged with the spool, movement of the handle in a first direction relative to the side walls rotates the spool in the web take-up direction, and a web tension limiting member configured to limit engagement of the handle with the spool so as to limit rotation of the spool by the handle in the web take-up direction to a predefined fraction of a full rotation of the spool.

### CROSS-REFERENCE TO RELATED APPLICATIONS

This patent application claims the benefit of, and priority to, U.S. Provisional Patent Application Ser. No. 63/356,159, filed Jun. 28, 2022, and also to U.S. Provisional Patent Application Ser. No. 63/324,778, filed Mar. 29, 2022, the disclosures of which are incorporated herein by reference in their entireties.

### TECHNICAL FIELD

The present disclosure relates generally to web retractors, and more specifically to ratcheting web retractors configured to releasably limit web tension.

### BACKGROUND

Ratcheting web retractors may typically be implemented in motor vehicle and/or cargo restraint systems to selectively pay-out and take-up restraint webs to secure cargo and/or other structure(s) in and/or relative to the motor vehicle. It may be desirable under certain operating conditions of some such ratcheting web retractors to selectively limit web tension so as to limit the restraint force of the web acting on the cargo and/or other structure(s).

### SUMMARY

The present disclosure may comprise one or more of the features recited in the attached claims, and/or one or more of the following features and combinations thereof. In a first aspect, a web retractor may comprise a frame including spaced-apart side walls, a spool rotatably mounted to and between the side walls, a web having one end mounted to the spool, the spool rotatable relative to the side walls in a web take-up direction to wrap the web onto the spool and in a web pay-out direction to unwrap the web from the spool, a handle movably mounted to the side walls and engageable with the spool such that, with the handle engaged with the spool, movement of the handle in a first direction relative to the side walls rotates the spool in the web take-up direction, and a web tension limiting member configured to limit engagement of the handle with the spool so as to limit rotation of the spool by the handle in the web take-up direction to a predefined fraction of a full rotation of the spool.

A second aspect may include the features of the first aspect, and may further comprise a lock pawl mounted to the side walls and configured to engage the spool and prevent the spool from rotating in the web pay-out direction while allowing the spool to rotate in the web take-up direction.

A third aspect may include the features of the second aspect, and may further comprise a toothed wheel fixed to the spool such that the toothed wheel rotates with the spool, wherein the handle includes a ratchet pawl biased into engagement with the toothed wheel such that, with the ratchet pawl engaged with the toothed wheel, movement of the handle in the first direction relative to the side walls rotates the spool in the web take-up direction.

A fourth aspect, may include the features of the third aspect, wherein the web tension limiting member includes a web tension limiting wheel having an outer surface defining a toothed section including at least one tooth and a non-toothed section adjacent to the toothed section, and wherein the ratchet pawl is also biased into engagement with the at least one tooth of the web tension limiting wheel such that movement of the handle in a first direction relative to the side walls causes the web tension limiting wheel to rotate in the web take-up direction for a predefined fraction of a full rotation of the spool after which the non-toothed section of the web tension limiting wheel blocks engagement of the ratchet pawl with the toothed wheel.

A fifth aspect may include the features of the fourth aspect, wherein the web tension limiting wheel is configured to engage the lock pawl so as to maintain the web tension limiting wheel in a position in which the web tension limiting wheel blocks engagement of the ratchet pawl with the toothed wheel.

A sixth aspect may include the features of the fifth aspect, and may further comprise means for disengaging the web tension limiting wheel from the lock pawl.

A seventh aspect may include the features of the sixth aspect, and may further comprise a biasing member coupled to and between the web tension limiting wheel and the frame, the biasing member configured to bias the web tension limiting wheel to a position in which the ratchet pawl is engageable with the at least one tooth of the web tension limiting wheel.

In an eighth aspect, a web retractor may comprise a frame including spaced-apart side walls, a spool rotatably mounted to and between the side walls, a toothed wheel fixed to the spool such that the spool and toothed wheel rotate together relative to the side walls, a web having one end mounted to the spool, the spool rotatable relative to the frame in a web take-up direction to wrap the web onto the spool and in a web pay-out direction to unwrap the web from the spool, a handle movably mounted to the side walls, a ratchet pawl mounted to the handle, and a web tension limiting wheel adjacent to the toothed wheel and movable relative to the side walls, the web tension limiting wheel having an outer surface defining a toothed section including at least one tooth and a non-toothed section adjacent to the toothed section, wherein the ratchet pawl is biased into engagement with the toothed wheel and with the at least one tooth of the web tension limiting wheel such that movement of the handle in a first direction relative to the side walls causes the spool and the web tension limiting wheel to rotate together in the web take-up direction for a predefined fraction of a full rotation of the spool after which the non-toothed section of the web tension limiting wheel blocks engagement of the ratchet pawl with the toothed wheel so as to limit rotation of the spool by the handle in the web take-up direction to the predefined fraction of the full rotation of the spool.

A ninth aspect may include the features of the eighth aspect, and may further comprise a biasing member coupled to and between the web tension limiting wheel and the frame, the biasing member configured to bias the web tension limiting wheel to a position in which the ratchet pawl is engageable with the at least one tooth of the web tension limiting wheel.

A tenth aspect may include the features of the ninth aspect, and may further comprise a lock pawl mounted to the side walls and configured to engage the toothed wheel and prevent the spool from rotating in the web pay-out direction while allowing the spool to rotate in the web take-up direction.

An eleventh aspect may include the features of the tenth aspect, and wherein the web tension limiting wheel is configured to engage the lock pawl so as to prevent the web tension limiting wheel from rotating, under bias of the biasing member, back to a position in which the ratchet pawl is engageable with the at least one tooth of the web tension limiting wheel.

A twelfth aspect may include the features of the eleventh aspect, and may further comprise means for disengaging the web tension limiting wheel from the lock pawl.

In a thirteenth aspect, a web retractor may comprise a frame including spaced-apart side walls, a spool rotatably mounted to and between the side walls, a first wheel fixed to the spool such that the spool and first wheel rotate together relative to the side walls, a web having one end mounted to the spool, the spool rotatable relative to the frame in a web take-up direction to wrap the web onto the spool and in a web pay-out direction to unwrap the web from the spool, a handle movably mounted to the side walls and engageable with the first wheel such that, with the handle engaged with the first wheel, movement of the handle in a first direction relative to the side walls rotates the spool in the web take-up direction, a web tension limiting member configured to limit engagement of the handle with the first wheel so as to limit rotation of the spool by the handle in the web take-up direction to a predefined fraction of a full rotation of the spool, a second wheel rotatably mounted to the frame and operatively coupled to the first wheel such that each of the first and second wheels is rotatably drivable by the other of the first and second wheels, and a power spring assembly coupled to the second wheel and configured to bias the second wheel to rotate in a direction which causes the first wheel to rotate the spool in the web take-up direction.

A fourteenth aspect may include the features of the thirteenth aspect, wherein the first wheel is a first toothed wheel, and wherein the handle includes a ratchet pawl biased into engagement with the first toothed wheel such that, with the ratchet pawl engaged with the first toothed wheel, movement of the handle in the first direction relative to the side walls rotates the spool in the web take-up direction.

A fifteenth aspect may include the features of the fourteenth aspect, wherein the web tension limiting member includes a web tension limiting wheel having an outer surface defining a toothed section including at least one tooth and a non-toothed section adjacent to the toothed section, and wherein the ratchet pawl is also biased into engagement with the at least one tooth of the web tension limiting wheel such that movement of the handle in the first direction relative to the side walls causes the web tension limiting wheel to rotate in the web take-up direction for a predefined fraction of a full rotation of the spool after which the non-toothed section of the web tension limiting wheel blocks engagement of the ratchet pawl with the first toothed wheel.

A sixteenth aspect includes the features of the fifteenth aspect, and may further comprise a biasing member coupled to and between the web tension limiting wheel and the frame, the biasing member configured to bias the web tension limiting wheel to a position in which the ratchet pawl is engageable with the at least one tooth of the web tension limiting wheel.

A seventeenth aspect may include the features of either of the fifteenth and sixteenth aspects, and may further comprise a lock pawl mounted to the side walls and configured to engage the toothed wheel and prevent the spool from rotating in the web pay-out direction while allowing the spool to rotate in the web take-up direction, wherein the web tension limiting wheel is configured to engage the lock pawl so as to maintain the web tension limiting wheel in a position in which the web tension limiting wheel blocks engagement of the ratchet pawl with the toothed wheel.

An eighteenth aspect may include the features of the seventeenth aspect, and may further comprise means for disengaging the web tension limiting wheel from the lock pawl.

A nineteenth aspect may include the features of the fourteenth aspect, wherein the second wheel is a second toothed wheel having teeth meshed with teeth of the first toothed wheel such that each of the first and second toothed wheels is rotatably drivable by the other of the first and second toothed wheels, and wherein the power spring assembly is configured to bias the second toothed wheel to rotate in the direction which, when transferred through the teeth of the second toothed wheel to the teeth of the first toothed wheel, biases the spool to rotate in the web take-up direction.

A twentieth aspect may include the features of any of the thirteenth through nineteenth aspects, wherein the frame includes a bottom wall coupled to and between respective ends of the spaced-apart side walls, and wherein the second toothed wheel and the power spring assembly are both coupled to the bottom wall in-board of the side-walls.

A twenty first aspect may include the features of any of the thirteenth through nineteenth aspects, wherein the frame includes a bottom wall coupled to and between respective ends of the spaced-apart side walls such that the spool is disposed within a space of the frame bounded by the side walls and an inner surface of the bottom wall, and wherein the web retractor further comprises a bracket mounted to an outer surface, opposite the inner surface, of the bottom wall, and wherein the second toothed wheel and the power spring assembly are both coupled to the bottom wall in-board of the side-walls, and wherein at least a portion of the second toothed wheel extends through an open section of the bottom wall and into engagement with the first toothed wheel.

A twenty second aspect may include the features of the twenty first aspect, wherein the spool is fixed to a shaft that is rotatably mounted to and between the side walls of the frame such that the spool rotates with the shaft relative to the side walls of the frame, wherein the bracket, the second toothed wheel and the power spring assembly together define a power spring arrangement, and wherein a total width of the power spring arrangement is no greater than a total width of the frame defined between external surfaces of the side walls or defined as a combination of a length of the shaft and the total width of the frame.

In a twenty third aspect, a web retractor may comprise a frame including spaced-apart side walls, a spool rotatably mounted to and between the side walls, a first wheel fixed to the spool such that the spool and first wheel rotate together relative to the side walls, a web having one end mounted to the spool, the spool rotatable relative to the frame in a web take-up direction to wrap the web onto the spool and in a web pay-out direction to unwrap the web from the spool, a second wheel rotatably mounted to the frame and operatively coupled to the first wheel such that each of the first and second wheels is rotatably drivable by the other of the first and second wheels, and a power spring assembly coupled to the second wheel and configured to bias the second wheel to rotate in a direction which causes the first wheel to rotate the spool in the web take-up direction.

A twenty fourth aspect may include the features of the twenty third aspect, wherein the first wheel is a first toothed wheel, and the second wheel is a second toothed wheel having teeth meshed with teeth of the first toothed wheel such that each of the first and second toothed wheels is rotatably drivable by the other of the first and second toothed wheels, and wherein the power spring assembly is configured to bias the second toothed wheel to rotate in the direction which, when transferred through the teeth of the second toothed wheel to the teeth of the first toothed wheel, biases the spool to rotate in the web take-up direction.

A twenty fifth aspect may include the features of either of the twenty third and twenty fourth aspects, wherein the frame includes a bottom wall coupled to and between respective ends of the spaced-apart side walls, and wherein the second toothed wheel and the power spring assembly are both coupled to the bottom wall in-board of the side-walls.

A twenty sixth aspect includes the features of the either of the twenty third and twenty fourth aspects, wherein the frame includes a bottom wall coupled to and between respective ends of the spaced-apart side walls such that the spool is disposed within a space of the frame bounded by the side walls and an inner surface of the bottom wall, and wherein the web retractor further comprises a bracket mounted to an outer surface, opposite the inner surface, of the bottom wall, and wherein the second toothed wheel and the power spring assembly are both coupled to the bottom wall in-board of the side-walls, and wherein at least a portion of the second toothed wheel extends through an open section of the bottom wall and into engagement with the first toothed wheel.

A twenty seventh aspect may include the features of the twenty sixth aspect, wherein the spool is fixed to a shaft that is rotatably mounted to and between the side walls of the frame such that the spool rotates with the shaft relative to the side walls of the frame, wherein the bracket, the second toothed wheel and the power spring assembly together define a power spring arrangement, and wherein a total width of the power spring arrangement is no greater than a total width of the frame defined between external surfaces of the side walls or defined as a combination of a length of the shaft and the total width of the frame.

### BRIEF DESCRIPTION OF THE DRAWINGS

FIG. 1 is a top plan view of an embodiment of a ratcheting web retractor including an embodiment of a releasable web tension limiter.

FIG. 2 is a side view of the ratcheting web retractor of FIG. 1 shown in a locked web operating mode with the ratchet handle positioned in a web locking notch of the frame.

FIG. 3A is a side view of the ratcheting web retractor of FIGS. 1 and 2 shown in a web ratcheting operating mode with the ratchet handle at a bottom stroke position relative to the frame.

FIG. 3B is a side view of the ratcheting web retractor similar to FIG. 3A but with the frame omitted to illustrate the releasable web tension limiter gear, with the ratchet handle at the bottom stroke position, biased to a ratcheting position.

FIG. 3C is a rear perspective view of the ratcheting web retractor of FIGS. 1 and 2 shown with the ratchet handle at the bottom stroke position as also depicted in FIGS. 3A and 3B.

FIG. 3D is a cross-sectional view of the ratcheting web retractor, as viewed in perspective along the section lines 3D,4C-3D,4C of FIG. 1, further illustrating the web tension limiter gear biased to the ratcheting position with the ratchet handle at the bottom stroke position.

FIG. 4A is a side view of the ratcheting web retractor in the web ratcheting mode similar to FIG. 3A but with the ratchet handle moved to a top stroke position relative to the frame.

FIG. 4B is a rear perspective view of the ratcheting web retractor of FIG. 4A also shown with the ratchet handle at the top stroke position relative to the frame.

FIG. 4C is a cross-sectional view of the ratcheting web retractor, as viewed in perspective along the section lines 3D,4C-3D,4C of FIG. 1, further illustrating the web tension limiter in a ratchet blocking position in response to movement of the ratchet handle to the top stroke position relative to the frame.

FIG. 4D is a rear perspective and magnified view of the ratcheting web retractor of FIGS. 4A-4C illustrating engagement of the web tension limiter gear with the lock pawl to fix the web tension limiter gear in the ratchet blocking position as also illustrated in FIG. 4C.

FIG. 5 is a rear perspective view of the ratcheting web retractor illustrating the web tension limiting gear in the ratchet blocking position in which a portion of the web tension limiting gear blocks engagement of the ratchet pawl with the ratchet gear in any position of the ratchet handle between the bottom and top stroke positions of the ratchet handle.

FIG. 6A is a side view of the ratcheting web retractor shown in a free-spooling operating mode with the ratchet handle moved to a free-spooling position relative to the frame to return the web tension limiter gear from the ratchet blocking position to the ratcheting position and to also disengage the lock pawl from the ratchet gears.

FIG. 6B is a side view of the ratcheting web retractor viewed from an opposite side of the retractor shown in FIG. 6A and with the frame removed to illustrate release of the lock pawl by a bottom lobe of the ratchet handle in the free-spooling position of the ratchet handle.

FIG. 7A is a side view of another embodiment of a ratcheting web retractor including an embodiment of a releasable web tension limiter.

FIG. 7B is a cutaway view of FIG. 7A with portions of the frame side wall and ratchet handle frame removed to show various internal features of the web retractor and web tension limiter.

FIG. 7C is a rear view of the ratcheting web retractor of FIGS. 7A and 7B.

FIG. 7D is a cross-sectional view of the ratcheting web retractor of FIGS. 7A-7C, as viewed along section lines 7D,E-7D,E.

FIG. 7E is a cross-sectional view similar to FIG. 7D shown with the ratchet handle advanced to engage the web tension limiter gear.

FIG. 8A is a side view similar to FIG. 7A shown with the ratchet handle fully advanced to transition the web retractor from a free spool operating mode to a locked operating mode.

FIG. 8B is a cutaway view of FIG. 8A with portions of the frame side wall and ratchet handle frame removed to show various internal features of the web retractor and web tension limiter.

FIG. 9 is a cutaway view similar to FIG. 8B shown with the ratchet handle rotated back toward the lock pawl with the web retractor in the locked operating mode.

FIG. 10A is an exploded view of another embodiment of a ratcheting web retractor including the web retractor and releasable web tension limiter illustrated in FIGS. 7A-9 modified to include another embodiment of a power spring assembly operatively mounted to the web retractor.

FIG. 10B is a bottom perspective, assembled view of the ratcheting web retractor illustrated in FIG. 10A.

FIG. 10C is a cutaway view of FIG. 10B with a portion of the frame side wall removed to show interdigitating engagement of the toothed gear of the web retractor and the toothed gear of the power spring assembly.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

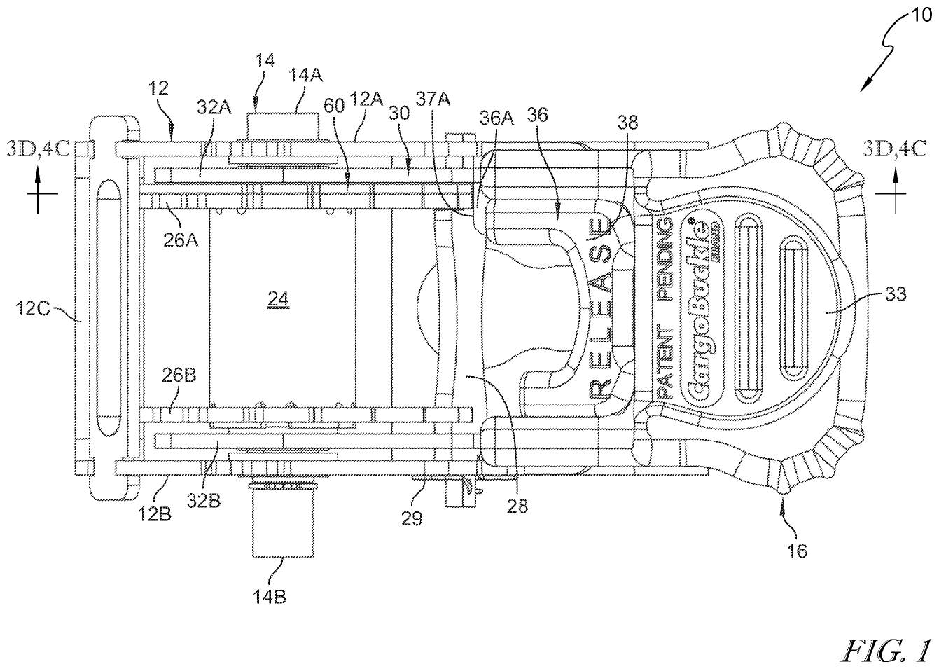

This disclosure relates to devices and techniques for releasably limiting tension applied by a ratcheting web retractor to an engaged web of the retractor. The term “engaged web” should be understood to mean that a free end of the web, i.e., the end of the web not operatively coupled to the ratcheting web retractor, is connected to or otherwise engaged with one or more structures external to the ratcheting web retractor. With reference to FIGS. 1A-6B, an example embodiment of a web retractor 10 is shown which includes an embodiment of a releasable web tension limiter 60 configured to limit engagement of a ratchet pawl 36, carried by a ratchet handle 16 of the retractor 10, with a web ratcheting gear or wheel 26A of the retractor 10 so as to correspondingly limit rotation of a web spool 24 of the retractor 10, to which one end of an engaged web 18 is operatively coupled, to a predefined rotation fraction in a web take-up direction of the retractor 10 to thereby limit the amount of tension that can be applied by the retractor 10 to the engaged web 18, i.e., the web 18 having an opposite end coupled to or otherwise engaged with one or more structures external to the retractor 10. In one illustrative embodiment, the releasable web tension limiter 60 is configured to limit such engagement of the ratchet pawl 36 with the web ratcheting gear or wheel 26A by blocking engagement of the ratchet pawl 36 with the web ratcheting gear or wheel 26A after the web spool 24 has been rotated the predefined rotation fraction by manual movement of the handle 16 with the ratchet pawl 36 engaged with the web ratcheting gear or wheel 26A, as will be described in detail below.

The web retractor 10 illustratively includes a number of conventional structural features operable in a conventional manner to control various conventional operating modes of the retractor 10. Such conventional structural features of the web retractor 10 and the various conventional operating modes of the retractor 10 will first be described, and thereafter details of an embodiment of the web tension limiter 60 integrated into the web retractor 10, as well as operation of the web tension limiter 60 in relation to the various operating modes of the web retractor 10, will be described.

Referring now to FIGS. 1-6B, an embodiment is shown of a ratcheting web retractor 10 (sometimes referred to as a ratcheting tie down, retractable ratchet tie down device or strap, ratcheting cargo strap or the like), which includes integrated therein an embodiment of web tension limiter 60. In the illustrated embodiment, the retractor 10 includes a frame 12, wherein the frame 12 includes spaced-apart upstanding side walls 12A, 12B joined at their base by a bottom wall 12C. The frame 12 illustratively defines an open U or C shape with the free ends of the spaced-apart side walls 12A, 12B each extending upwardly away from the bottom wall 12C. A rotatable shaft 14 is rotatably mounted to and between the side walls 12A, 12B of the frame 12 such that one end 14A of the shaft 14 extends through the side wall 12A and an opposite end 14B of the shaft 14 extends through the side wall 12B, and such that the shaft 14 rotates about a rotational axis 14C between and relative to the side walls 12A, 12B in a conventional manner. A conventional spool 24 is mounted over the shaft 14, e.g., the shaft 14 is received within the spool 24 and is coupled thereto, such that the shaft 14 and the spool 24 rotate together relative to the side walls 12A, 12B of the frame 12.

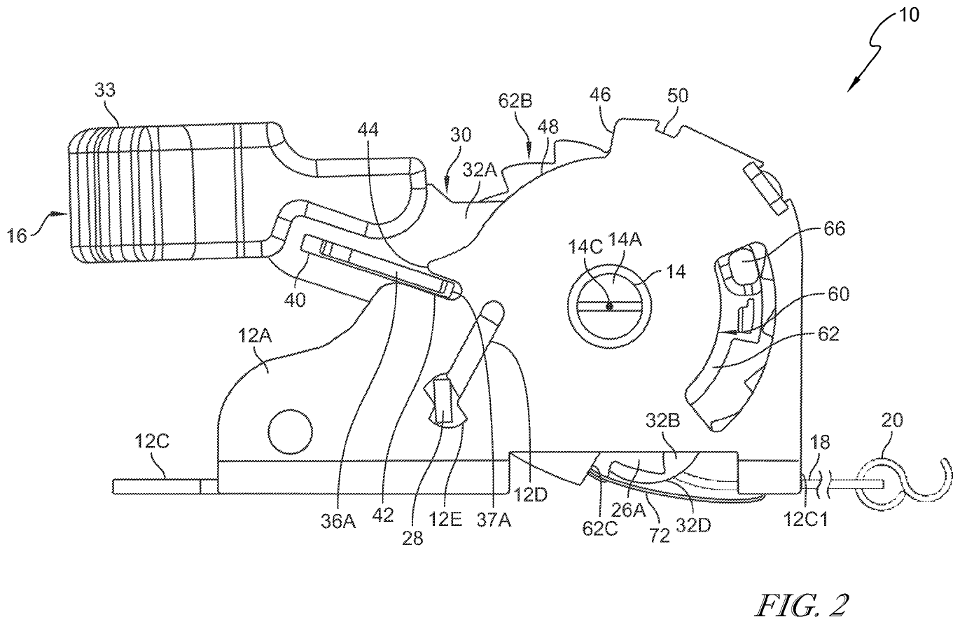

One end of a conventional web 18 is attached or affixed to the spool 24, and at least a portion of the web 18 is wrapped about the spool 24 in a conventional manner. An opposite free end of the web 18 extends outwardly from the frame 12 as depicted by example in FIG. 2. The web 18 is illustratively a conventional flexible or semi-flexible web, and at least a portion of the web 18 is windable about the spool 24. In some embodiments, as also depicted by example in FIG. 2, an engagement member 20, e.g., a hook or other conventional engagement member, is attached or affixed to the free end of the web 18, and may be used to couple to or otherwise engage one or more structures to be secured to and/or by the retractor 10 or to couple to or otherwise engage one or more structures so as to secure cargo by and between the retractor 10 and the one or more structures. It will be understood that whereas the engagement member 20 is depicted in FIG. 2 in the form of a hook, this depiction is provided only by way of example, and that the engagement member 20 may alternatively be any conventional engagement device, apparatus or assembly, without limitation, configured to be coupled to the free end of the web 18 and configured to engage one or more structures external to the retractor 10, and/or to engage a portion of the retractor 10, a structure attached to the retractor 10 or the web 18 itself, after wrapping a portion of the web 18 between the retractor 10 and the engagement device at least partially about one or more structures to be restrained. In any case, a ratchet handle 16 is movably mounted to the side walls 12A, 12B of the frame 12, and is movable relative to the side walls 12A, 12B in a conventional manner to and/or between a number of different positions relative to the sidewalls 12A, 12B according to each of a plurality of different operational modes of the retractor 10, as will described in further detail below.

In the illustrated embodiment, the bottom wall 12C and/or a side wall 12A of the frame 12 is illustratively configured to mount to a structure, examples of which may include, but are not limited to, a mobile structure such as a motor vehicle, a trailer or the like, any stationary structure such as a wall, floor, pallet or other product transport device or assembly, a rail or frame member coupled to a motor vehicle, trailer or stationary structure, or the like. As also in the illustrated embodiment, the web 18 illustratively exits the frame 12 adjacent to a forward edge 12C1 of the bottom wall 12C of the frame 12.

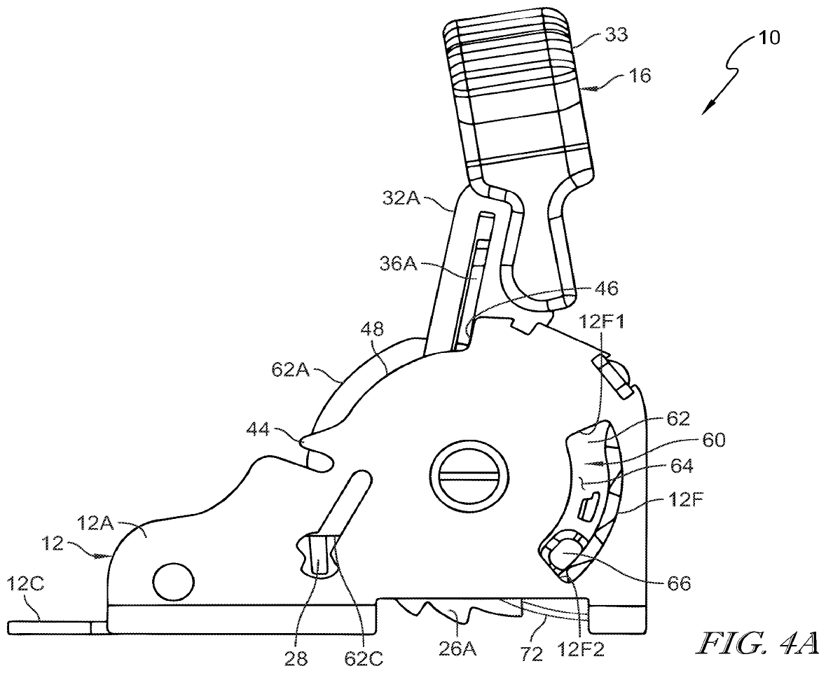

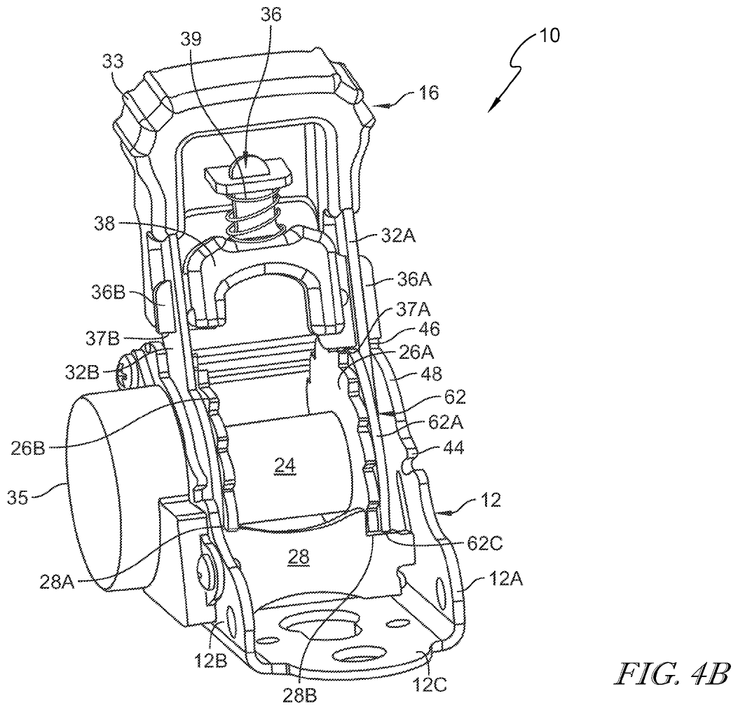

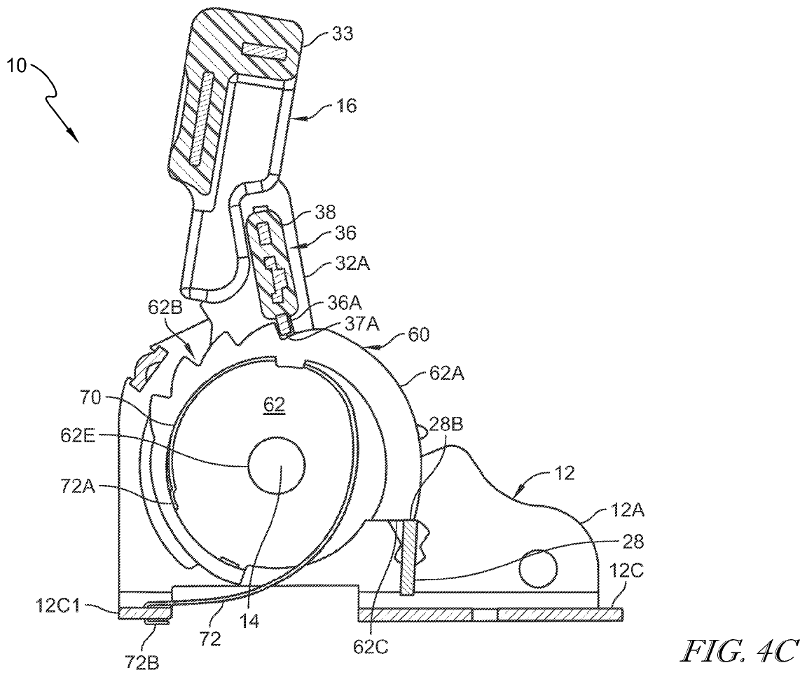

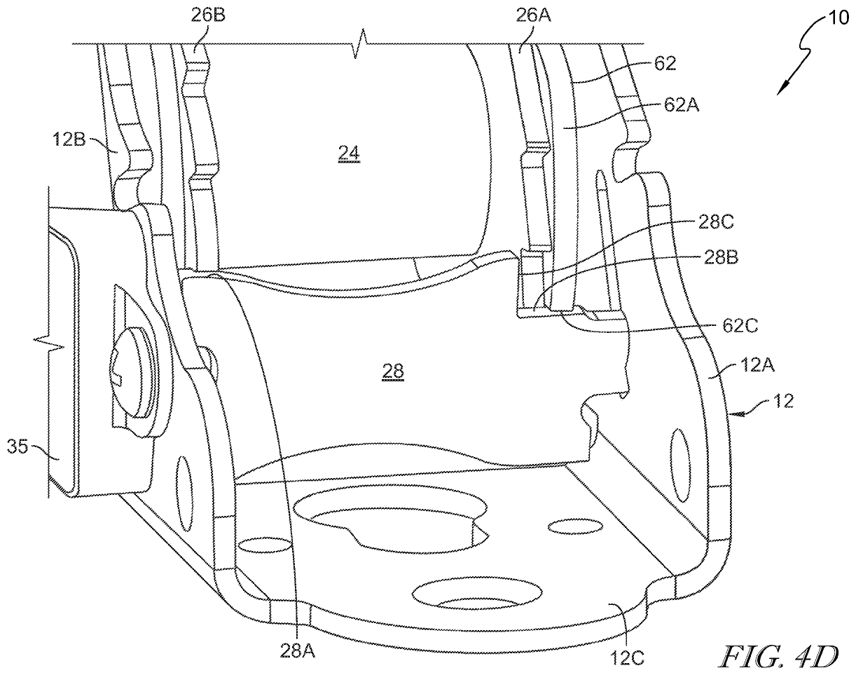

The spool 24 is rotatable about the spool axis 14C in a web pay-out direction in which the web 18 is paid out from the spool 24 and exits the retractor 10 adjacent to the front edge 12C1 of the bottom wall 12C, and also in an opposite web take-up direction in which the web 18 is taken up into the retractor 10 and wound upon and around the spool 24. As illustrated by example in FIGS. 4B and 4D, the web retractor 10 illustratively includes a power spring assembly 35 mounted to the outer surface of the sidewall 12B of the retractor frame 12. The power spring assembly 35 is conventional and includes at least one conventional biasing member, e.g., a coiled spring, configured to engage the respective end 14B of the shaft 14, and/or a portion of the shaft 14 adjacent to the end 14B, and to bias the shaft 14 and spool 24 to rotate in the web take-up direction. To draw web 18 from the retractor 10 (without the spool 24 rotationally locked or otherwise impeded as described below), sufficient force must be applied to the web 18 in the web pay-out direction, i.e., out of and away from the retractor 10, to overcome the biasing force of the biasing member of the power spring assembly 35 as is conventional.

At least one toothed web ratcheting gear or wheel is operatively mounted to the spool 24 and/or shaft 14 so as to rotate with the spool 24 and shaft 14 relative to the side walls 12A, 12B of the frame 12. In one embodiment, the at least one toothed gear or wheel includes a toothed gear or wheel 26A mounted at or near one end of the shaft 14 and/or spool 24 adjacent to but spaced apart from the inwardly-facing surface of the side wall 12A of the frame 12. In some embodiments, the at least one toothed wheel or gear may alternatively or additionally include another toothed gear or wheel 26B, similar or identical to the toothed gear or wheel 26A, mounted at or near an opposite end of the shaft 14 and/or spool 24 adjacent to but spaced apart from the inwardly-facing surfaced of the side wall 12B of the frame 12, as illustrated by example in FIGS. 1-6B.

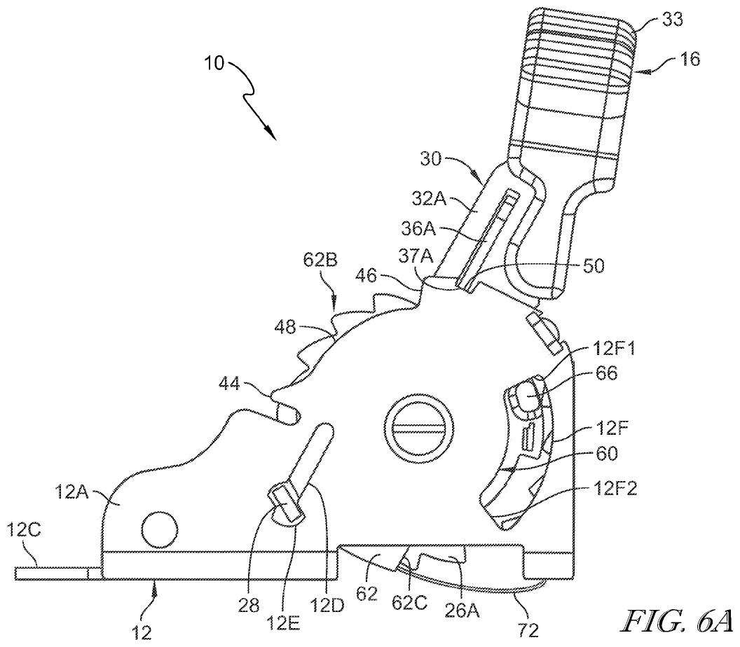

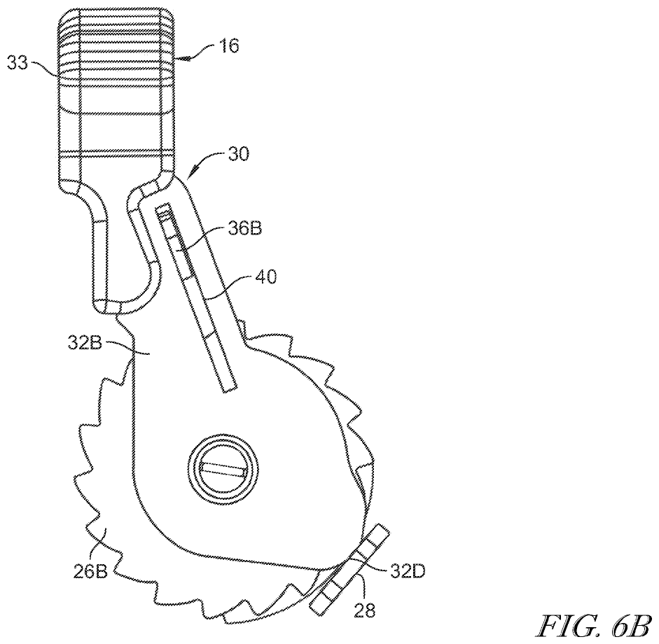

The side walls 12A, 12B of the frame 12 each define a slot 12D therethrough terminating at an opening 12E defined through the side wall 12A, 12B at a bottom end of the slot 12D. A conventional lock pawl 28 is movably mounted to and between the side walls 12A, 12B and above the bottom wall 12C, with opposite ends of the lock pawl 28 being received through the openings 12E as shown. The lock pawl 28 is illustratively rotatable toward and away from the spool 24, within and relative to the openings 12E defined through the side walls 12A, 12B, between a locked position in which the lock pawl 28 is rotated toward the spool 24 and engages the toothed wheel 26A between adjacent pairs of teeth, as illustrated by example in FIGS. 1, 3C, 4B and 4D, and an unlocked position in which the lock pawl 28 is rotated away from the spool 24 such that the lock pawl 28 does not engage the toothed wheel 26A, as illustrated by example in FIGS. 6A and 6B. A biasing member 29, e.g., a spring, is illustratively coupled to and between the side wall 12B of the frame 12 and a respective end of the lock pawl 28, and operates to bias the lock pawl 28 toward the locked position. The teeth defined on the toothed wheel 26A are illustratively oriented in a conventional manner, e.g., arcuate-shaped in a common direction, such that with the lock pawl 28 engaging the toothed wheel 26A, the lock pawl 28 prevents the spool 24 from rotating in the web pay-out direction, i.e., so that the web 18 cannot be paid out of the retractor 10, but allows the spool 24 to rotate in the web take-up direction with the lock pawl 28 riding against the outer surfaces of the teeth in response to rotational movement of the ratchet handle 16 relative to the frame 12 as described more fully below. With the lock pawl 28 disengaged from the toothed wheel 26A, the lock pawl 28 does not prevent or impede the spool 24 from rotating in the web take-up direction or the pay-out direction.

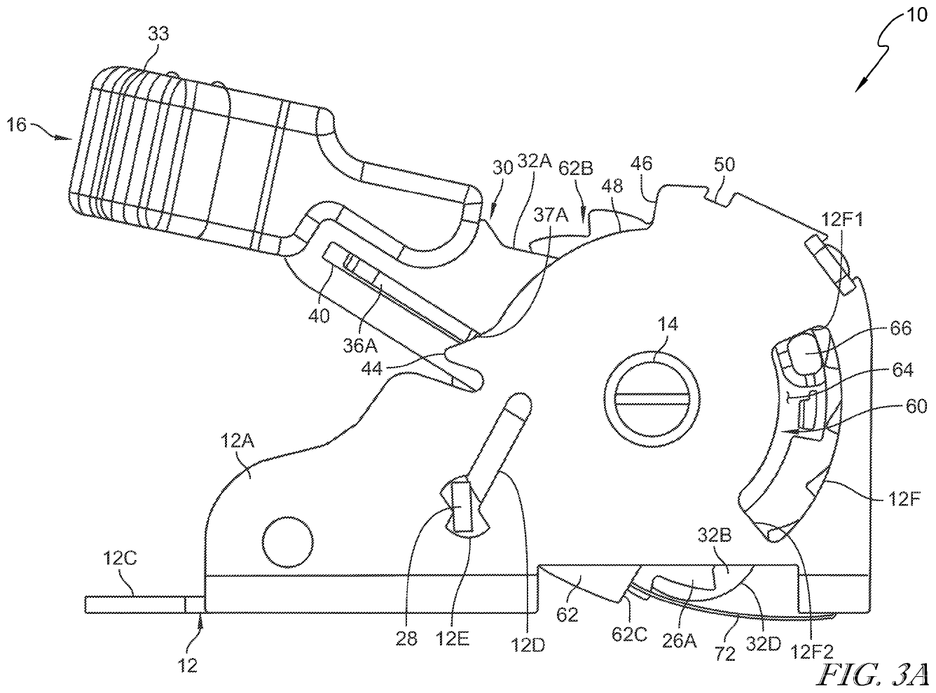

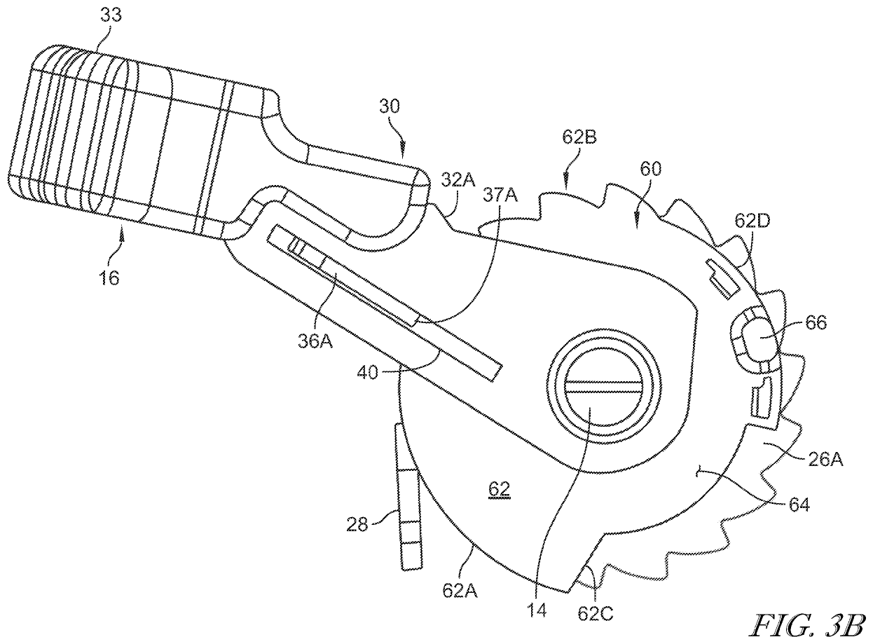

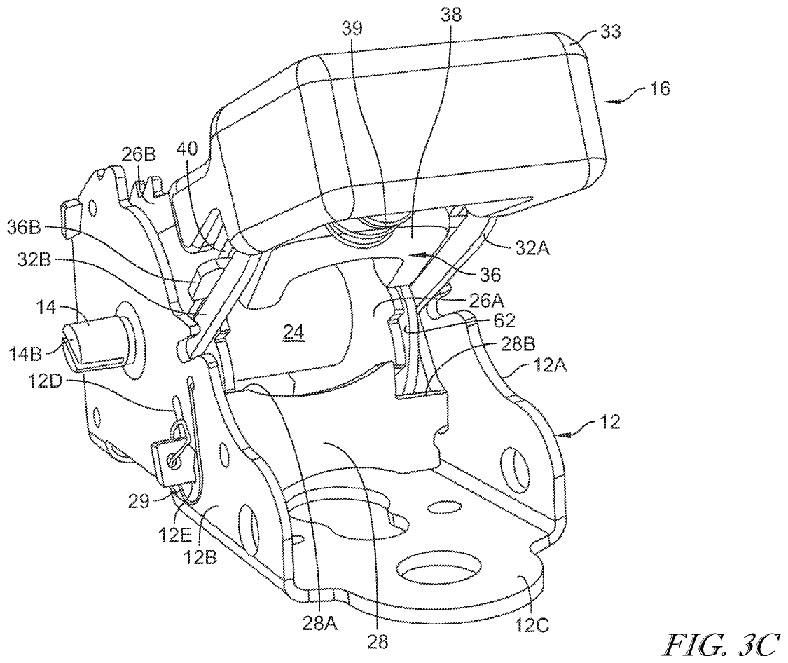

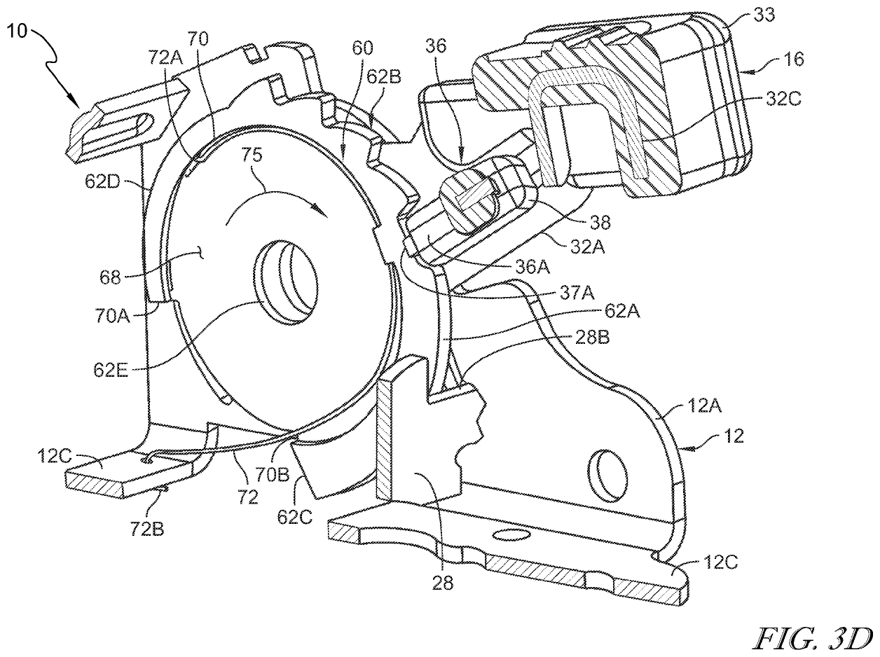

The ratchet handle 16 is illustratively formed of a handle frame 30 having spaced-apart side members 32A, 32B joined at their top ends by a top frame member 32C (see FIG. 3D). A handle grip 33, e.g., flexible, rigid or semi-rigid material, is fitted onto and secured to the top frame member 32C. The shaft 14 passes through the side frame members 32A, 32B adjacent to the free ends of the side members 32A, 32B and on either side of the spool 24 such that, by themselves (i.e., without the ratchet pawl 36 mounted thereto as described below), the side members 32A, 32B of the handle frame 30 rotate about, and not with, the shaft 14 or spool 24. The side frame member 32A is illustratively positioned between the toothed gear or wheel 26A and the inwardly-facing surface of the side wall 12A of the frame, and the side frame member 32B is illustratively positioned between the toothed gear or wheel 26B and the inwardly-facing surface of the side wall 12B of the frame 12. One end of a ratchet pawl 36 extends through an opening in the top frame member 32C (see FIG. 4B). One wing 36A of the ratchet pawl 36 extends through a slot 40 defined through the side frame member 32A of the handle frame 30, and another wing 36B of the ratchet pawl 36 extends through a slot 40 defined through the side frame member 32B (see FIG. 3C). The free end 37A of the wing 36A extends downwardly toward and into engagement with the toothed wheel 26A. In some embodiments, the free end 37B of the wing 36B may terminate so as not to engage the toothed wheel 26B, as illustrated by example in FIGS. 1 and 3C, although in alternate embodiments the free end 37B of the wing 36B of the ratchet pawl 36 may, in addition to or alternatively to the wing 36A extending into contact with the toothed wheel 26A, extend downwardly into contact with the toothed wheel 26B. A biasing member 39, e.g., a coiled spring, biases the ratchet pawl 36, and thus free end 37A of the wing 36A of the ratchet pawl 36, toward the toothed wheel 26A and the top of the side wall 12A of the frame 12, as illustrated by example in FIGS. 1-4C and 5-6A. A ratchet pawl grip 38, e.g., flexible, rigid or semi-rigid material, is fitted onto and secured to the ratchet pawl 36.

The ratchet pawl 36 is illustratively movable against the bias of the biasing member 39, e.g., manually and/or by the top portion of the side wall 12A and/or by the web tension limiter 60, relative to the handle frame 30 between a locked position in which the free end 37A of the ratchet pawl 36 engages the toothed wheel 26A between adjacent pairs of teeth, and an unlocked position in which the ratchet pawl 36 is spaced apart from the spool 24 such that the free end 37A of the ratchet pawl 36 does not engage the toothed wheel 26A. In some positions of the ratchet handle 16, the top surface of the side walls 12A acts on the end 37A of the ratchet pawl 36 allow the ratchet pawl 36 to move under bias of the biasing member 39 to its locked position to engage the toothed wheel 26A, and in other positions of the ratchet handle 16 the top surface of the side wall 12A acts on the end 37A of the ratchet pawl 36 to maintain the ratchet pawl 36 in its unlocked position by preventing the ratchet pawl 36 from moving under bias of the biasing member 39 into engagement with the toothed wheel 26A, as will be described in detail below. When the ratchet pawl 36 is in the locked position and the web tension limiter 60 is in a ratcheting position as will be described below, the end 37A of the ratchet pawl 36 engages the toothed wheel 26A between adjacent pairs of teeth such that upward and forward movement, e.g., rotation, of the handle 16 relative to the frame 12 from a bottom stroke position, illustrated by example in FIGS. 3A-3D, to a top stroke position, illustrated by example in FIGS. 4A-4C, causes the combination of the handle 15 and the ratchet pawl 36 to engage the toothed gear or wheel 26A and the web tension limiter 60 to rotate the spool 24 in the web take-up direction, as will be described in detail below.

As depicted by example in FIGS. 2, 3A, 4A, 4B and 6A, the top surface of the side wall 12A defines a number of features which allow the retractor 10 to operate in several different operating modes, as described briefly above. Referring specifically to FIGS. 1, 2, 3A, 4A, 4B and 6A, for example, the top edge surfaces of the side walls 12A, 12B each define a notch or channel 42 extending into the top edge of the side walls 12A, 12B at or near a bottom end thereof, e.g., adjacent to the top of the channel 12D defined through the side walls 12A, 12B, a protrusion 44 adjacent to the notch 42, a stop wall 46 at or near a top of the side walls 12A, 12B, and an arcuate region 48 extending between the notch 44 and the stop wall 46. Beyond the stop wall 46 is another notch 50 extending into the top edge of the side walls 12A, 12B. The protrusion 44 is thus positioned between the notch 42 and the arcuate region 48, the arcuate region 48 is positioned between the protrusion 44 and the stop 46, the stop 46 is positioned between the arcuate region 48 and the notch 50, and the notch 50 is positioned beyond the stop 46.

With the side or wing 36A of the ratchet pawl 36 disposed in the notch 42 of the side wall 12A, as illustrated by example in FIG. 2, the handle 16 is prevented from moving along and relative to the top surfaces of the side walls 12A, 12B. This is the locked position of the handle 16 and the locked web operating mode of the retractor 10 in which the lock pawl 28 is in its locked position with the top edge 28A abutting the toothed wheel 26B between adjacent teeth thereof to prevent the spool 24 from rotating in the web pay-out direction, and in which the side or wing 36A of the ratchet pawl 36 positioned in the notch 42 of the side wall 12A prevents the handle 16 from advancing the spool 24 in the web take-up direction. In one embodiment, the end 37A of the wing 36A of the ratchet pawl 36, while positioned in the notch 42, abuts the toothed wheel 26A, between adjacent teeth thereof, although in alternate embodiments the ratchet pawl 36 may be configured such that the end 37A of the wing 36A, while positioned in the notch 42, is prevented by the web tension limiter 60 from engaging the toothed wheel 26A. In order to position the side 36A of the ratchet pawl 36 within the notch or channel 42, the ratchet pawl grip 38 is manually drawn toward the handle grip member 33, i.e., against the bias of the biasing member 39, so that the sides 36A, 36B of the ratchet pawl 36 are drawn toward the handle grip 33 along the channels 40 defined through the side members 32A, 32B of the handle frame 30, and the ratchet handle 16 is then moved, e.g., rotated, about the spool 24 and relative to the top surfaces of the side walls 12A, 12B toward the notches 42 defined in the side walls 12A, 12B. It will be noted that sufficient force must be applied to the ratchet pawl grip 38 to draw the sides 36A, 36B of the ratchet pawl 36 over the protrusion 44 extending from the top surfaces of the side walls 12A, 12B so that the sides 36A, 36B of the ratchet pawl 36 may then be positioned, via manual manipulation of the ratchet handle 16, over the channels or notches 42. With the sides 36A, 36B positioned over and aligned with the channels or notches 42, the ratchet pawl grip 38 is then released and the side 36A of the ratchet pawl 36 passes, under bias of the biasing member 39, into the channel 42 defined in the side wall 12A as illustrated by example in FIG. 2. This position of the ratchet handle 16 relative to the frame 12 is referred to as the “locked” position of the ratchet handle 16, as both the lock pawl 28 and the ratchet pawl 36 abut the toothed wheels 26A, 26B, thereby preventing rotation of the spool 24 in the web pay-out direction. Typically, although not exclusively, the ratchet handle 16 may be placed in the “locked” position illustrated in FIG. 2 after the engagement member 20 has been coupled to another structure and the web 18 has subsequently been drawn taut by ratcheting the ratchet handle 16, as described below, to draw at least some of the web 18 onto the spool 24 in the web take-up direction.

Referring now specifically to FIGS. 3A-3D, the web ratcheting position of the handle 16 and the web ratcheting mode of the retractor 10 is shown. In order to relocate the side 36A of the ratchet pawl 36 from the notch 42 illustrated in FIG. 2 to the web ratcheting region 48 of the frame 12, the ratchet pawl grip 38 is manually drawn toward the handle grip member 33, i.e., against the bias of the biasing member 39, so that the sides 36A, 36B of the ratchet pawl 36 are drawn toward the handle grip 33 along the channels 40 defined through the side members 32A, 32B of the handle frame 30, and the ratchet handle 16 is then moved, e.g., rotated, relative to the top surfaces of the side walls 12A, 12B toward the region 48. It will be noted that sufficient force must be applied to the ratchet pawl grip 38 to draw the side 36A of the ratchet pawl 36 over the protrusion 44 extending from the top surfaces of the side wall 12A so that the sides 36A of the ratchet pawl 36 may then be positioned, via manual manipulation of the ratchet handle 16, over the region 48. With the sides 36A moved past the protrusion 44 and positioned over the web ratcheting region 48 adjacent thereto, the ratchet pawl grip 38 is then released and the end 37A of the side 36A of the ratchet pawl 36 passes, under bias of the biasing member 39, onto, i.e., into contact with, the web ratcheting region 48 as illustrated by example in FIG. 3A, and such that the free end 37A of the ratchet pawl 36 also abuts the toothed wheel 26A between adjacent teeth thereof as illustrated by example in FIGS. 3B and 3C. In this position, the ratchet handle 16 is at a bottom stroke position.

With the free end 37A of the ratchet pawl 36 riding on the web ratcheting region 48 of the frame side wall 12A in the ratcheting position of the handle 16, as illustrated in FIG. 3A, the spool 24 is prevented by both the lock pawl 28 and the ratchet pawl 36 from rotating in the web pay-out direction. From this bottom stroke position of the ratchet handle 16, the ratchet handle 16 may be moved along the ratcheting region 48 toward, and to, a top stroke position where further movement of the handle 16 is blocked by engagement of the wing 36A of the ratchet pawl 36 with the stop 46, as illustrated by example in FIG. 4A. As the ratchet handle 16 moves, e.g., rotates, toward the stop 46, the free end 37A of the ratchet pawl 36 engaged between teeth of the toothed wheel 26A rotates the spool 24 in the web take-up direction while also riding along the top edge of the side wall 12A in the web ratcheting region 48, and the upper edge 28A of the lock pawl 28 rides against the outer surfaces of the teeth of the toothed wheel 26B, as illustrated in FIG. 4B.

Referring now specifically to FIGS. 6A and 6B, the web release position of the handle 16 and the free-spooling operating mode of the retractor 10 is shown. In this position and operating mode, the handle 16 has been rotated upwardly from the top stroke position of the web ratcheting handle 16 just described such that the end 37A of the side or wing 36A of the ratchet pawl 36 passes over the stop 46 and is positioned in the notch 50. With the end 37A of the side 36A of the ratchet pawl 36 disposed in the notch 50, the ratchet pawl 36 is in its unlocked position with the free end 37A spaced apart from, and therefore not in contact with, the toothed wheel 26A. In order to position the side 36A of the ratchet pawl 36 in the channel 50 from the web ratcheting region 48 illustrated in FIG. 4A, the ratchet pawl grip 38 is manually drawn toward the handle grip member 33, i.e., against the bias of the biasing member 39, so that the sides 36A, 36B of the ratchet pawl 36 are drawn toward the handle grip 33 along the channels 40 defined through the side members 32A, 32B of the handle frame 30, and the ratchet handle 16 is then moved, e.g., rotated, relative to the top surfaces of the side walls 12A, 12B toward the notch 50. It will be noted that sufficient force must be applied to the ratchet pawl grip 38 to draw the side 36A of the ratchet pawl 36 over the stop wall 46 so that the side 36A of the ratchet pawl 36 may then be positioned, via manual manipulation of the ratchet handle 16, over the notch 50. With the sides 36A moved past the stop wall 46 and positioned over and aligned with the notch 50, the ratchet pawl grip 38 is then released and the end 37A of the side 36A of the ratchet pawl 36 passes, under bias of the biasing member 39, into the notch 50, as illustrated in FIG. 6A. In the process of moving the ratchet handle 16 to reposition the side 36A of the ratchet pawl 36 from the ratcheting region 48 adjacent the stop 46 to the notch 50 as just described, a lobe 32D defined at the lower end of the side member 32B of the handle frame 30 comes into contact with the lock pawl 28 and forces the lock pawl 28 away from, and out of contact with, the toothed wheel 26B, as illustrated by example in FIG. 6B. This position of the ratchet handle 16 relative to the frame 12 is referred to as the “free-spooling” position of the ratchet handle 16 (and the free-spooling operating mode of the retractor 10), because neither the lock pawl 28 nor the ratchet pawl 36 is in contact with the toothed wheels 26A, 26B, and the spool 24 may thus be freely rotated in either direction, e.g., in the web take-up direction under bias of the spool biasing member 35 or in the web pay-out direction by moving the web 18 in the web pay-out direction with a force greater than that of the spool biasing member 35.

As briefly described above, the web retractor 10 further includes a releasable web tension limiting apparatus 60 configured to limit engagement of the ratchet pawl 36 with the toothed wheel 26A during the web ratcheting mode of operation of the retractor 10 so as to limit rotation of the spool 24 to a predefined rotation fraction, i.e., a predefined fraction of a complete (360 degree) rotation of the spool 24, in the web take-up direction. Such limiting of the rotation of the spool 24 in the web take-up direction limits the amount of tension applied by the retractor 10 to the engaged web 18, i.e., to the web 18 having an opposite end coupled to or otherwise engaged with one or more structures external to the retractor 10. As described in detail below, the web tension limiter 60 has a ratcheting position in which the web tension limiter allows the ratchet pawl 36 to engage the toothed wheel 26A so that the ratchet handle 16 may be moved relative to the frame 12 to cause the spool 24 to rotate in the web take-up direction while the lock pawl 28 is engaged with the toothed wheel 26B to thereby “ratchet” the a portion of the web 18 onto the spool 24, and a ratchet blocking position in which the web tension limiter 60 blocks engagement of the ratchet pawl 36 with the toothed wheel 26A while the lock pawl 28 remains engaged with the toothed wheel 26B so that any movement ratchet handle 16 relative to the frame 12 between the bottom and top stroke positions of the ratchet handle 16 will not result in rotation of the spool 24 in the web take-up direction, thereby limiting a magnitude of tension that may be applied to the engaged web 18.

In the embodiment illustrated in FIGS. 1-6B, the releasable web tension limiting apparatus (or web tension limiter) 60 includes a partially toothed gear or wheel 62 received on the shaft 14 so as to rotate about and relative to the shaft 14. The toothed wheel 62 is illustratively positioned next to, e.g., in contact with or spaced apart from, the toothed gear or wheel 26A such that the partially toothed gear or wheel 62 is disposed on the shaft 14 between the toothed gear or wheel 26A and the inwardly-facing surface of the side wall 12A of the frame 12, with an outer major surface 64 of the wheel 62 facing the inwardly-facing surface of the side wall 12A and with an inner major surface 68 of the wheel 62 facing the toothed gear or wheel 26A. The gear or wheel 62 illustratively defines an opening 62E centrally therethrough which is received on the shaft 14 and which has a diameter at least slightly larger than that of the shaft 14 such that the gear or wheel 62 is rotatable relative to and about the shaft 14.

The outer periphery or outer edge of the gear or wheel 62 between the major surfaces 64, 68 illustratively includes a non-toothed section 62A, e.g., illustratively with a smooth or semi-smooth surface, a toothed section 62B having one end beginning at one end of the non-toothed section 62A, wherein an opposite end of the non-toothed section 62A terminates at a step 62C. An opposite end of the toothed section 62B terminates at another non-toothed section 62D, such that the toothed section 62B is disposed between the non-toothed sections 62A, 62D. The toothed section 62B illustratively includes 4 teeth, although in alternate embodiments the toothed section 62B may have more or fewer teeth. The teeth (or tooth) of the toothed section 62B is/are illustratively configured identically to the teeth defined on the toothed gear or wheel 26A, e.g., arcuate shaped in and along the same direction as the teeth defined on the toothed wheel or gear 26A, although in alternate embodiments the shape(s) of one or more of the teeth or tooth defined on the toothed section 62B may be different than that of the gear or wheel 26A. In one embodiment, the radius of the toothed section 62B from the center of the opening 62E to the tip(s) of the tooth/teeth is identical to the radius of the toothed gear or wheel 26A from the center of rotation of the toothed gear or wheel 26A to the tips of the teeth defined thereon, such that the tip(s) of the tooth/teeth of the toothed section 62B align, i.e., is/are substantially co-terminus, with the teeth defined on the toothed gear or wheel 26A. In alternate embodiments, the two radii may be different from one another. In any case, the teeth/tooth defined on the toothed section 62B of the gear or wheel 62 and the teeth defined on the toothed gear or wheel 26A are similar enough in shape, and the radii of the gears or wheels 26A, 62 are similar enough, such that the end 37A of the side or wing 36A of the ratchet pawl 36 can simultaneously engage both gears or wheels 26A, 62 between adjacent teeth thereof (or, in single-tooth embodiments of the gear or wheel 62, against the single tooth) such that the handle 16 can simultaneously ratchet both gears or wheels 26A, 62 upwardly along the arcuate path defined by the region 48 of the frame 12 toward, and in some embodiments to, the stop 46.

In the illustrated embodiment, the major surface 64 of the partially toothed gear or wheel 62 illustratively defines a protrusion 66 which extends outwardly away from, e.g., perpendicularly away from, the major surface 64 of the gear or wheel 62. The side wall 12A of the frame 12 of the retractor 10 illustratively defines a slot or channel 12F therethrough which is sized and located so as to receive the protrusion 66 therein. The slot or channel 12F is illustratively arcuate in shape between opposite terminal ends 12F1, 12F2 thereof, such that the protrusion 66 of the gear or wheel 62 is movable along the slot or channel 12F as the gear or wheel 62 rotates relative to the shaft 14. In some embodiments, at least one of the terminal ends 12F1, 12F2 of the slot or channel 12F serves as a stop to rotation of the gear or wheel 62 relative to the sidewall 12A of the frame 12 as the protrusion 66 makes contact therewith.

The opposite major surface 68 of the gear or wheel 62 illustratively defines an arcuate channel 70 therein sized to receive a biasing member 72, e.g., an elongated, arcuate spring, therein. One end 72A of the spring 72 is coupled to the gear or wheel 62 at, within the channel 70 and spaced apart from one end 70A of the channel 70, e.g., the one end 70A of the channel 70 defined at or near the terminal end of the non-toothed section 62D of the gear or wheel 62. The spring 72 extends, within the channel 70, at least partially circumferentially around the gear or wheel 62, and exits at, or spaced apart from, an opposite end 70B of the channel 70, e.g., the opposite end 70B of the channel defined at or near the step 62C which defines the terminal end of the non-toothed section 62A of the gear or wheel 62. An opposite end 72B of the spring 72 is attached to the frame 12, e.g., to a portion of the bottom wall 12C of the frame adjacent to the forward or front edge 12C1.

The biasing member 72 is illustratively biases the gear or wheel 62 in the web pay-out direction 75, as illustrated by the arcuate arrow 75 in FIG. 3D, until, in some embodiments, the gear or wheel 62 stopped by contact of the protrusion 66 with the upper terminal end 12F1 of the channel 12F defined through the side wall 12A of the retractor frame 12. It will be understood that the biasing member 72 illustrated in FIGS. 3D and 4C is provided only by way of example, and that in alternative embodiments any conventional biasing member or biasing members of any shape and/or size may be engaged to and between the gear or wheel 62 and the frame 12 to bias the gear or wheel 62 to rotate in the web pay-out direction 75 as just described. With the handle 16 positioned in the bottom stroke position of the web ratcheting operating mode of the web retractor 10 illustrated in FIGS. 3A-3D, i.e., with the free end 37A of the side or wing 36A of the ratchet pawl 36 in contact with the portion of the arcuate top edge 48 of the side wall 12A next to, e.g., just above, the protrusion 44, the tooth/teeth of the gear or wheel 62 is/are aligned with the teeth of the gear or wheel 26A such that the free end 37A of the side or wing 36A of the ratchet pawl 36 is in contact with the gear or wheel 26A between adjacent teeth thereof as described above, and is also in contact with the gear or wheel 62 against a tooth thereof positioned just above the side or wing 36A as illustrated by example in FIG. 3D. In the embodiment illustrated in FIGS. 1-6B, the free end 37A of the side or wing 36A of the ratchet pawl 36 is in contact with the first of four teeth defined on the toothed section 62B of the gear or wheel 62. In some alternative embodiments, the tooth in contact with the free end 37A of the side or wing 36A of the ratchet pawl 36 in the position of the handle 16 illustrated in FIGS. 3A-3D may be the only tooth, one of less than four teeth or one of more than four teeth, defined on the toothed section 62B of the gear or wheel 62. In other alternate embodiments, the toothed portion 62B of the gear or wheel 62 may be configured such that, with the handle 16 in the bottom stroke position just described, the free end 37A of the side or wing 36A of the ratchet pawl 36 may be in contact with the gear or wheel 62 between two adjacent teeth defined on the toothed section 62B of the gear or wheel 62. In any case, with the ratchet handle 16 in the locked or bottom stroke position as illustrated by example in FIGS. 2 and 3A-3D respectively, the biasing member 72 illustratively biases the web tension limiter gear 62 to the ratcheting position in which the ratchet pawl 36 may engage the toothed section 62B of the web tension limiter gear 62 and rotate the web tension limiter gear 62, along with the spool 24, in the web take-up direction of the spool against the bias of the biasing member 72.

As the ratchet handle 16 is moved upwardly in the web ratcheting mode of the retractor 10, from the bottom stroke position illustrated in FIGS. 3A-3D toward the top stroke position of the ratchet handle 16, the end 37A of the side or wing 36A of the ratchet pawl 36 moves along, and in contact with, the arcuate top surface 48 of the side wall 12A of the frame 12 toward the stop 46, taking with it gear or wheel 26A via engagement between the end 37A of the wing 36A and a respective tooth of the gear or wheel 26A, and also taking with it the gear or wheel 62, also via engagement between the end 37A of the wing 36A and a respective tooth of the gear or wheel 62, such that the shaft 14, spool 24, gear or wheel 26A and gear or wheel 62A all rotate together in the web take-up direction. As the side or wing 36A of the ratchet pawl 36 nears the stop 46 defined in the top edge of the side wall 12A of the frame 12 (i.e., the top stroke position of the ratchet handle 16), the step 62C defined at the terminal end of the gear or wheel 62 clears a top wall 28B defined in a downward notch 28C of the lock pawl 28 which causes the lock pawl 28 to further rotate, under bias of the biasing member 29, toward and into further engagement with the toothed gear or wheel 26A as particularly illustrated by example in FIG. 4D. Illustratively, the protrusion 66 is, in this position of the web tension limiter gear 62, adjacent to or contacting the terminal wall 12F2 of the channel 12F defined in the side wall 12A of the frame 12, as illustrated by example in FIG. 4A. In any case, if/when the ratchet handle 16 is thereafter moved, e.g., rotated, downwardly back toward the bottom stroke position, the step 62C defined at the terminal end of the gear or wheel 62 is forced downwardly, under the biasing force of the biasing member 72, onto and against the top wall 28B of the lock pawl 28, thereby locking the gear or wheel 62 in the ratchet blocking position of the gear or wheel 62 in which only the non-toothed section 62A of the gear or wheel 62 extends alongside the arcuate section 48 of the top edge of the side wall 12A of the frame 12 between the protrusion 44 and the stop 46 as illustrated by example in FIGS. 4 and 4A-4D.

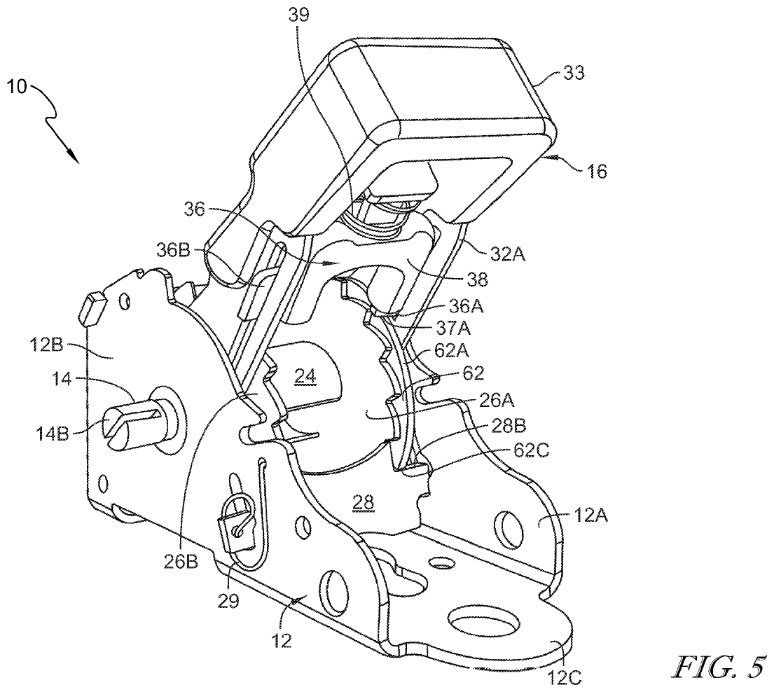

As best illustrated in FIG. 5, the radius of the non-toothed section 12A of the gear or wheel 62, between the center of the opening 62E and the top edge of the non-toothed section 62A, is greater than the radius of the gear or wheel 26A from the center of rotation of the toothed gear or wheel 26A to the tips of the teeth defined thereon. With the gear or wheel 62 of the web tension limiter 60 locked in the ratchet blocking position illustrated by example in FIGS. 4A-5, the end 37A of the side or wing 36A of the ratchet pawl 36 rides only on and along the top edge of the non-toothed section 62A of the gear or wheel 62 as the handle 16 is moved between the bottom and top stroke positions, and is thus prevented by the non-toothed section 62A from engaging the toothed wheel 26A, and in this regard the ratchet blocking position of the web tension limiter 60 may also be referred to herein as the spool rotation prevention position of the web tension limiter 60. Rotation of the gear or wheel 26A, and thus rotation of the spool 24, in the web take-up direction, in the ratchet blocking or spool rotation prevention position of the web tension limiter 60, is thus limited by the web tension limiter 60 to a fraction of a full rotation of the gear or wheel 26A and spool 24. In the illustrated embodiment, this fraction is the angular amount of rotation of the spool 24 in response to movement of the ratchet handle 16 between the bottom and top stroke positions of the ratchet handle 16, wherein the bottom stroke position, or lower ratchet position, of the ratchet handle 16 is defined by contact of the end 37A of the side or wing 36A of the ratchet pawl 36 with the protrusion 44 defined by the side wall 12A, which stops downward rotation of the handle 16 as described above, and the top stroke position, or upper ratchet position, of the ratchet handle 16 is defined by contact of the side or wing 36A of the ratchet pawl 36 with the stop 46 defined by the side wall 12A, which stops upward rotation of the handle 16 as also described above. In alternate embodiments, the web tension limiter 60 may be configured to provide for more or less angular amount of rotation of the spool 24 between the ratcheting and ratchet blocking positions of the web tension limiter 60.

With the gear or wheel 62 locked in the ratchet blocking or spool rotation prevention position illustrated in FIGS. 4A-5, the top edge of the non-toothed section 62A of the gear or wheel 62 prevents engagement of the end 37A of the side or wing 36A of the ratchet pawl 36 with the gear or wheel 26A between any teeth thereof as just described regardless of the position of the ratchet handle 16 between the bottom and top stroke positions described above. This is depicted by example in FIG. 5 which shows the web tension limiter gear 62 in the ratchet blocking or spool rotation prevention position illustrated in FIGS. 4A-4D and described above, and which further shows the ratchet handle 16 rotated to a position approximately midway between the bottom and top stroke positions. In this position of the ratchet handle 16, FIG. 5 clearly shows that the non-toothed section 62A of the web tension limiter gear or wheel 62 blocks engagement of the end 37A of the side or wing 36A of the ratchet pawl 36 with the toothed ratchet wheel 26A so that the spool 24 cannot be advanced any further in the web take-up direction. Rotation of the spool 24 in the web pay-out direction is, in this position, prevented by the locked position of the lock pawl 28 as described above, and the position of the spool 24 is thus locked and prevented from rotation in either direction.

In the illustrated embodiment, the web tension limiter 60 just described is operable to limit rotation of the spool 24 to one upward ratcheting movement of the handle 16 between the bottom and top stroke positions, or lower and upper ratcheting positions respectively, of the handle 16, as described above. Depending upon the geometries of the various components of the retractor 10, one movement of the handle 16 of the illustrated retractor 10 between the lower and upper ratchet positions thereof may cause the spool 24 to rotate between approximately 15-60 degrees of a full 360 degree rotation of the spool 24, and the web tension limiter 60 may be operable to thus limit rotation of the spool 24 to between approximately 15-60 degrees of rotation. It will be understood, however, that in alternate embodiments, a greater or lesser degree of rotation of the spool 24 may be attainable with one movement of the handle 16 of the retractor 10 between the lower and upper ratchet positions thereof or between other definable positions of the ratchet handle 16 relative to the frame 12, and such greater or lesser degree of rotation is intended to fall within the scope of the claims appended hereto. It will be further understood that the non-toothed section 62A and/or the toothed section 62B of the gear or wheel 62 may be alternately configured such that the gear or wheel 62, and thus the web tension limiter 60, is configured to limit upward ratcheting movement of the handle 16 to less than or more than one full upward ratcheting movement of the handle 16 between the lower and upper ratcheting positions thereof, e.g., such as by modifying the position(s) of the teeth or tooth of the toothed section 62B relative to the protrusion 44, the stop 46 and/or the arcuate section 48 of the top edge of the side wall 12A and/or by modifying the location of the step or edge 62C of the terminal end of the non-toothed section 62A relative to the top wall 28B of the lock pawl 28. In any case, the web tension limiter 60 is operable, as just described, to limit rotation of the spool 24 in the web take-up direction to a fraction of a full rotation of the spool 24. With the engagement member 20 attached to the free end of the web 18 coupled to a structure external to the retractor 10, the web tension limiter 60 is accordingly configured and operable to limit the tension applied by the retractor 10 to the engaged web 18 to the amount of tension applied by the retractor 10 to the engaged web resulting from the fractional rotation of the spool 24 allowed by the web tension limiter 60.

The web tension limiter 60 is illustratively resettable from the ratchet blocking or spool rotation prevention position illustrated in FIGS. 4A-5 and described above, to the spool release or ratcheting position of the web tension limiter 60 illustrated in FIGS. 1-3D and also described above. To reset the web tension limiter 60 to the spool release or ratcheting position thereof, the handle 16 is actuated as described above to the free-spooling position illustrated by example in FIGS. 6A and 6B and described above. As the handle 16 is moved to the free-spooling position in which the end 37A of the side or wing 36A of the ratchet pawl 36 is received within the notch 50, the lobe 32D defined at the lower end of the side member 32B of the handle frame 30 comes into contact with the lock pawl 28 and forces the lock pawl 28 away from, and out of contact with, the toothed wheel 26B against the bias of the biasing member 29. This forced movement of the lock pawl 28 away from the toothed wheel 26B also forces the top edge 28B of the lock pawl 28 away from the step 62D defined at the end of the non-toothed section 62A of the web tension limiter gear or wheel 62, thus causing the biasing member 72 to rotate the web tension limiter gear or wheel 62 relative to the shaft 14 in the direction 75 (see FIG. 3D) until the protrusion 66 of the gear or wheel 62 comes into to contact with the top terminal wall 12F1 of the channel 12F defined in the side wall 12A of the frame 12 as illustrated by example in FIG. 6A, thereby repositioning the gear or wheel 62 in the ratcheting or spool release position of the web tension limiter gear or wheel 62 illustrated by example in FIGS. 1-3D.

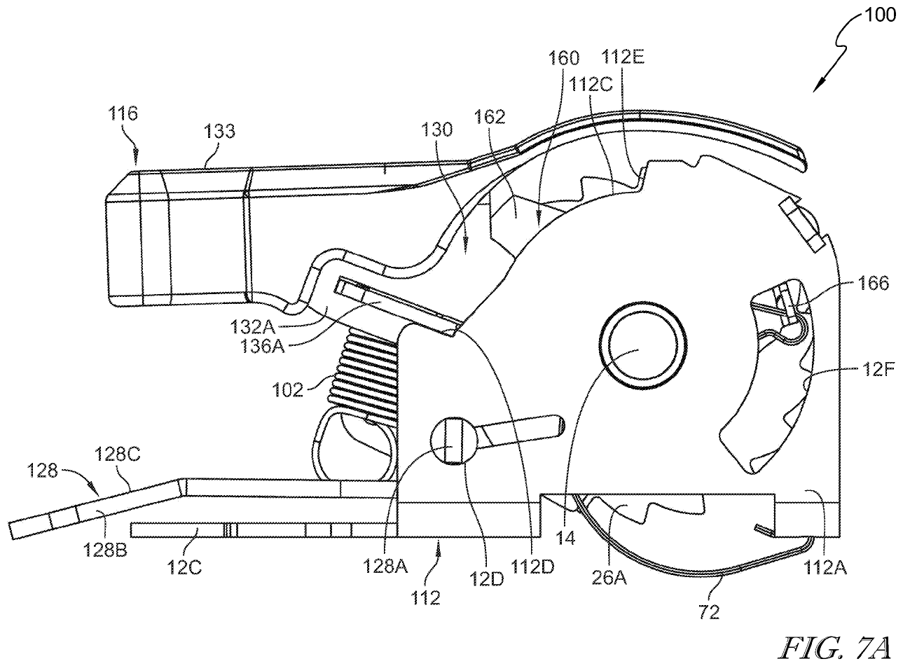

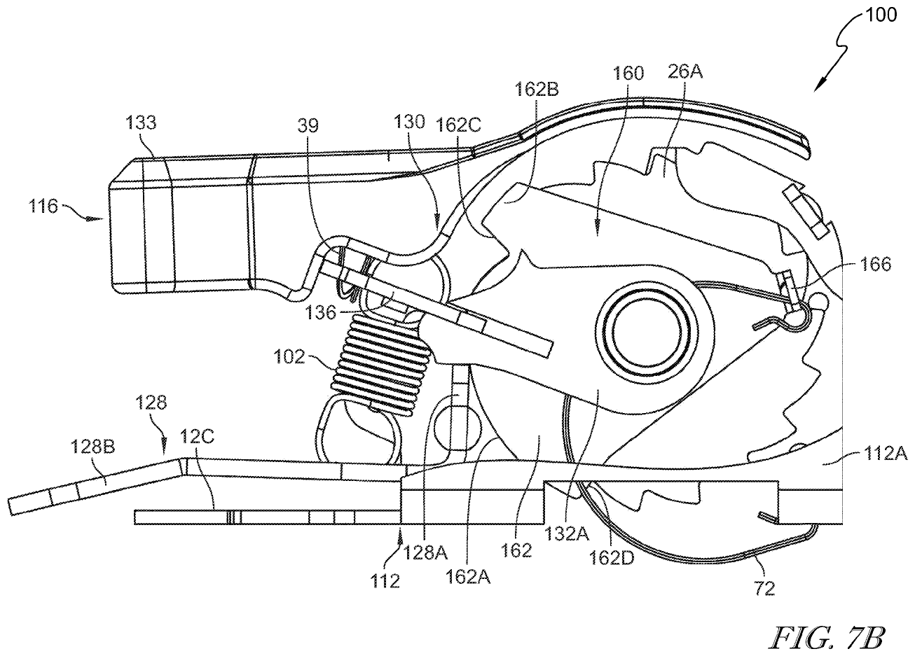

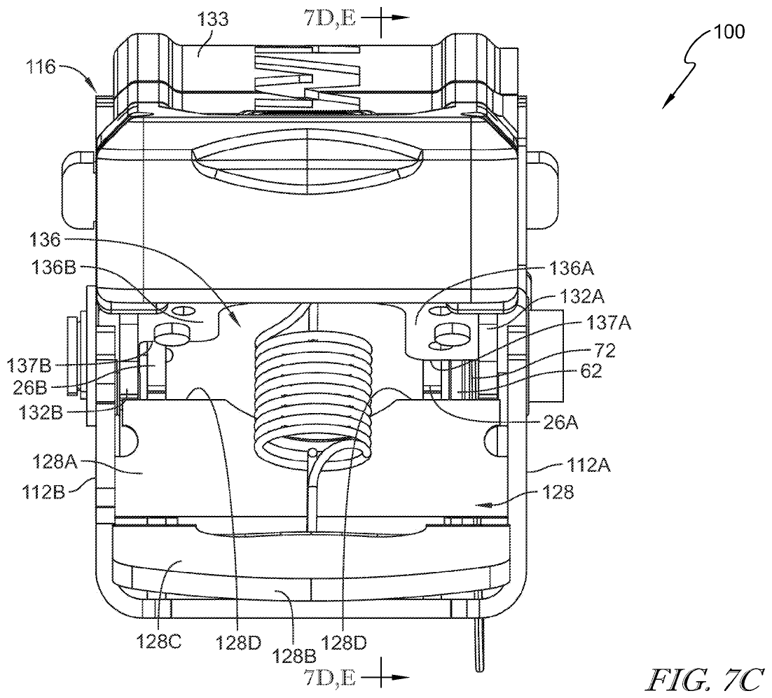

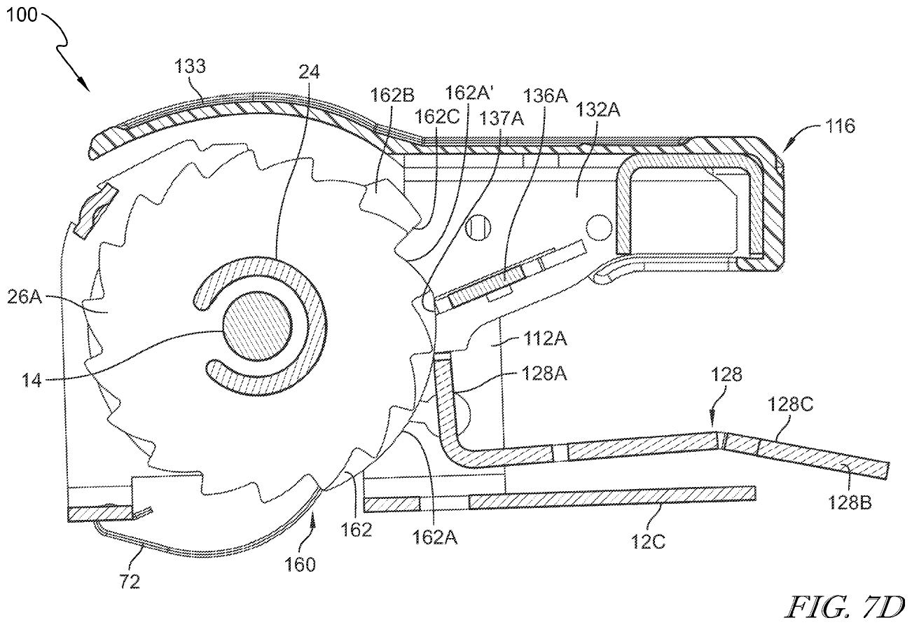

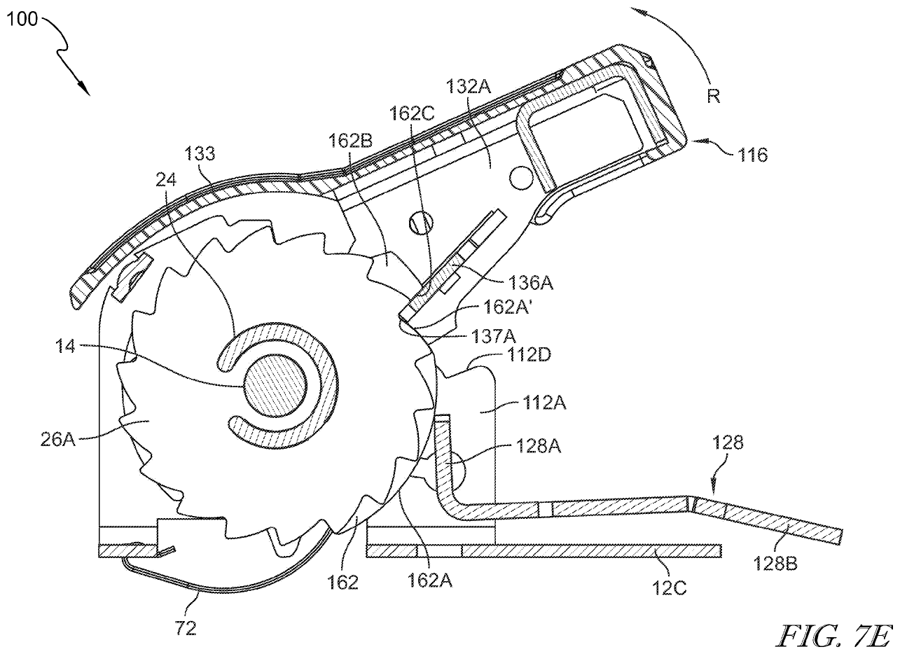

Referring now to FIGS. 7A-9, another embodiment is shown of a web retractor 100 which includes another embodiment of a releasable web tension limiter 160 configured to limit engagement of a ratchet pawl 136, carried by a ratchet handle 116 of the retractor 100, with the web ratcheting gears 26A, 26B of the retractor 100 so as to correspondingly limit rotation of the web spool 24 of the retractor 100, to which one end of an engaged web 18, is operatively coupled, to a predefined rotation fraction in a web take-up direction of the spool 24 of the retractor 100 to thereby limit the amount of tension that can be applied by the retractor 100 to the engaged web 18. The embodiment illustrated in FIGS. 7A-9 illustratively includes at least some of the same components of the web retractor 10 illustrated in FIGS. 1-6B and described above, and like numbers are used in FIGS. 7A-9 to identify such like components. The structural features of the retractor 100 and of the releasable web tension limiter 160, as well as the different operating modes of the retractor 100, illustratively differ somewhat from the embodiment of FIGS. 1-6B as will be described below, although the general function and operation of the combination of the retractor 100 and the releasable web tension limiter 160 is generally the same as described with respect to FIGS. 1-6B. Although not depicted in any of FIGS. 7A-9 for ease and clarity of illustration, it will be understood that the web retractor 100 will include a web 18 operatively coupled to the spool 24 and, in some embodiments, an engagement member 20 coupled to the free end of the web 18 as illustrated by example in FIG. 2, and a power spring assembly 35 as illustrated by example in FIGS. 4B and 4D.

In the embodiment illustrated by example in FIGS. 7A-9, the frame 112 is generally identical to the frame 12 illustrated in FIGS. 1-6B except for the profiles of the top edge surfaces of the side walls 112A and 112B. In embodiment of FIGS. 7A-9, the top edge surfaces of the side walls 112A, 112B both include an arcuate region 112C defined between a lower stop wall 12D at one end and an upper stop wall 12E at an opposite end. The ratchet handle 116 is also substantially identical to the ratchet handle 16 illustrated in FIGS. 1-6B and described above except that the handle grip 133 illustratively extends over the spool portion of the frame 112, and the ratchet pawl grip 38 is omitted from the ratchet pawl 136, and such that the free ends 137A, 137B of the sides 136A, 136B of the ratchet pawl 136 are each configured to engage a respective one of the toothed gears or wheel 26A, 26B. In this embodiment, the ratchet pawl 136 is not manually actuated, i.e., by a user, as described above, but is instead always biased, via the biasing member 39, toward the top edges of the side walls 112A, 112B of the frame 112 and toward the toothed gears or wheels 26A, 26B. With respect to the top edges of the side walls 112A, 112B of the frame 112, the ratchet pawl 136 is guided by movement of the handle 116 along the arcuate region 112C between the lower and upper stop walls 112D, 112E respectively. The handle 116 includes a handle frame 130 including spaced apart frame members 132A, 132B similar to the frame members 32A, 32B of the handle frame 30 described above, although in the embodiment illustrated in FIGS. 7A-9 the end(s) of the frame member(s) 132A, 132B are not configured to control the retractor 100 to a free spool mode as described above.

The web retractor 100 further differs from the web retractor 100 in that the lock pawl 128 illustratively includes a lock bar 128A movably mounted to the side walls 112A, 112B of the frame 112 such that the lock bar 128A is movable, e.g., rotatable, toward (and into contact with) and away from the toothed wheels 26A, 26B, and an actuating flange or tab 128B extending outwardly away from the lock bar 128A rearwardly of the frame 112. In the illustrated embodiment, the lock bar 128A and the actuating flange or tab 128B are of unitary construction, although in alternate embodiments the lock bar 128A and the actuating tab 128B may be provided as separate components and subsequently attached to one another in a conventional manner. In any case, the actuating flange or tab 128B includes a top surface 128C extending between a free end of the actuating tab 128B and the lock bar 128, and the lock bar 128 includes top engaging edges 128D positioned and configured to engage the toothed wheels 26A, 26B, as illustrated by example in FIG. 7C. The top surface 12C of the actuating tab 12B is illustratively sized so as to be accessible to a user for manual manipulation of the lock pawl 128. A biasing member 102, e.g., a coil spring, is coupled to and between the handle 116 and the actuating tab 28B between the terminal end of the actuating tab 28B and the locking bar 12A. The biasing member 102 is illustratively configured and operable to bias the handle 116 and the actuating tab 128B of the lock pawl 128 toward one another.

The releasable web tension limiter 160 is similar in many respects to the web tension limiter 60 illustrated in FIGS. 1-6B and described above. For example, the web tension limiter 160 includes a web tension limiter wheel or disk 162 configured to be mounted to the shaft 14 between the toothed gear or wheel 26A and the side wall 112A of the frame 112 such that the wheel or disk 162 is rotatable about the shaft 14 relative to the side wall 112A and relative to the toothed gear or wheel 26A. One end of the biasing member 72 described above is affixed to the gear or wheel 162, e.g., at a protrusion 166, and an opposite end is attached to the frame 112, e.g., to the bottom wall 12C of the frame 112, wherein the biasing member 72 illustratively extends about the shaft 14 between the wheel or disk 162 and the sidewall 112A of the frame 112.

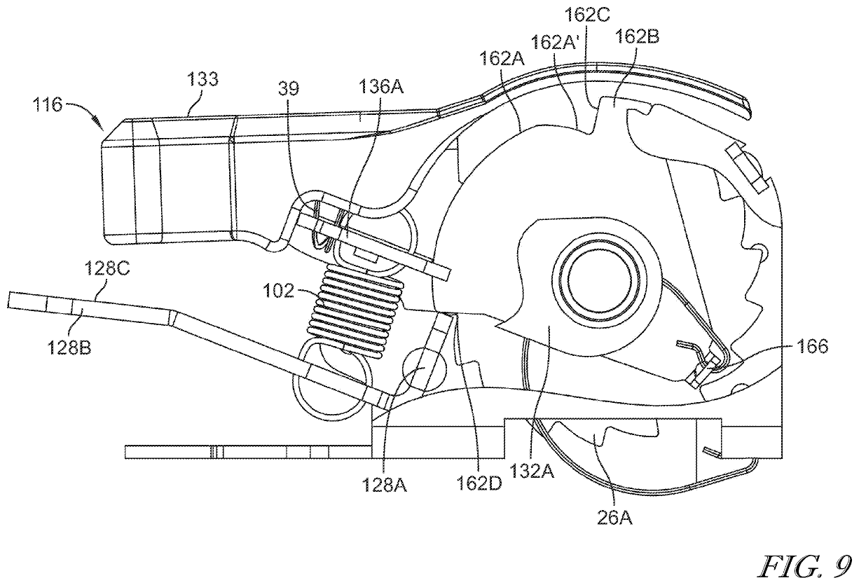

In the embodiment illustrated in FIGS. 7A-9, the web tension limiter gear or wheel 162, has a non-toothed portion 162A having a lower end which terminates at a step 162D, and an upper end which terminates at a toothed section. Unlike the web tension limiter gear or wheel 62, the web tension limiter gear or wheel 162 has only a single tooth 162B which defines a step 162C at a transition between the non-toothed section 162A and the tooth 162B. Adjacent to the step 162B, the non-toothed section defines a recessed portion 162A′ which transitions the outer surface of the gear or wheel 162 from the generally constant radius of the non-toothed section 162A to a reduced radius at the step 162C of the tooth 162B (see, e.g., FIG. 9).

In the embodiment illustrated in FIGS. 7A-9, the retractor 100 has three operating modes. One such operating mode of the retractor 100 is a free spool mode in which the web tension limiter 160 prevents engagement of both the lock pawl 128 and the ratchet pawl 136 with the toothed gears or wheels 26A, 26B, such that the power spring assembly 35 (see, e.g., FIGS. 4B and 4D) causes the shaft 14 and the spool 24 to rotate in a web take-up direction to wind the web 18 onto and around the spool 24, and such that the web 18 may be drawn from the retractor 100 against the bias of the power spring 35, as described above with respect to FIGS. 1-6B. Another operating mode of the retractor 100 is a locked mode in which the web tension limiter 160 allows the lock bar 128A of the lock pawl 128 to engage the toothed wheels or gears 26A, 26 while preventing engagement between the ratchet pawl 136 and the toothed wheels or gears 26A, 26B, such that the lock pawl 128 prevents the spool 24 from rotating in the web take-up direction and the web tension limiter 160 prevents the ratchet pawl 136 from engaging the toothed gears or wheels 26A, 26B so that no tension may be applied to the web 18 by operation of the ratchet handle 116. A further operating mode of the retractor 100 is a ratcheting or web tensioning mode in which the web tension limiter 160 allows the ratchet pawl 136 to engage the toothed wheels or gears 26A, 26B for a fraction of a rotation of the spool 24 by corresponding movement of the ratchet handle 116 relative to the frame 12, at the end of which the web tension limiter 160 causes the web retractor 100 to transition to the locked mode.

The free spool mode of the retractor 100 is illustrated by example in FIGS. 7A-7D. In the free spool mode, the ratchet handle 116 is drawn toward the lock pawl 128 under bias of the spring 102 such that the wings 136A, 136B of the ratchet pawl 136 are biased by the spring 102 into engagement with the step 112D at one end of the arcuate region 112C of the side walls 112A, 112B of the frame 112, as depicted by example in FIG. 7A. Further in the free spool mode, the biasing force of the elongated biasing member 72 causes the web tension limiter gear or wheel 162 to rotate in the web pay out direction to a position in which the protrusion 166 abuts the top of the arcuate slot 12F formed in the frame 12, as also depicted in FIG. 7A. In these positions of the ratchet handle 116 and the web tension limiter gear or wheel 162, the non-toothed portion 162A of the web tension limiter gear or wheel 162 forces the ends 137A, 137B of the wings 136A, 136B of the ratchet pawl 136 away from the toothed gear or wheel 26A, 26B, and further forces the lock bar 128A of the lock pawl 128 away from the toothed gear or wheel 26A, 26B as depicted by example in FIG. 7D.

In the free spool mode of the retractor 100, the tooth 162B and step 162C of the web tension limiter gear or wheel 162 is positioned some distance away from the lower step 112D of the arcuate region 112C of the side walls 112A, 112B of the frame 112 as shown by example in FIGS. 7B and 7D. As the ratchet handle 116 is rotated in the web take up direction relative to the frame 112 at the beginning of the ratcheting or web tensioning mode of the retractor 100, the ends 137A, 137B of the wings 136A, 136B of the ratchet pawl 136 follow along non-toothed portion 162A of the web tension limiter gear or wheel 162 toward the tooth 162B. When the ratchet pawl wings 136A, 136B reach the recessed portion 162A′ of the non-toothed portion 162A, the ends 137A, 137B of the wings 136A, 136B of the ratchet pawl 136 are guided by the recessed portion 162A′ into engagement with the toothed gears 26A, 26B as the ratchet pawl wings 136A, 136B reach the step 162C at the transition to the tooth 162B as depicted by example in FIG. 7E. In this position, the non-toothed portion 162A of the web tension limiter gear or wheel 162 keeps the lock bar 128A of the lock pawl 128 disengaged from the toothed wheel or gears 26A, 26B against the biasing force of the spring 102 as the ratchet handle 116 moves in the web take up direction. As rotation of the ratchet handle 116 in the web take up direction continues, e.g., in the direction R illustrated in FIG. 7E, the wings 136A, 136B of the ratchet pawl 136 engage the combination of the toothed gears or wheels 26A, 26B and the step 162C of the tooth 162B of the web tension limiter gear or wheel 162, and cause both to rotate in the web take up direction, thereby applying tension to the engaged web 18.

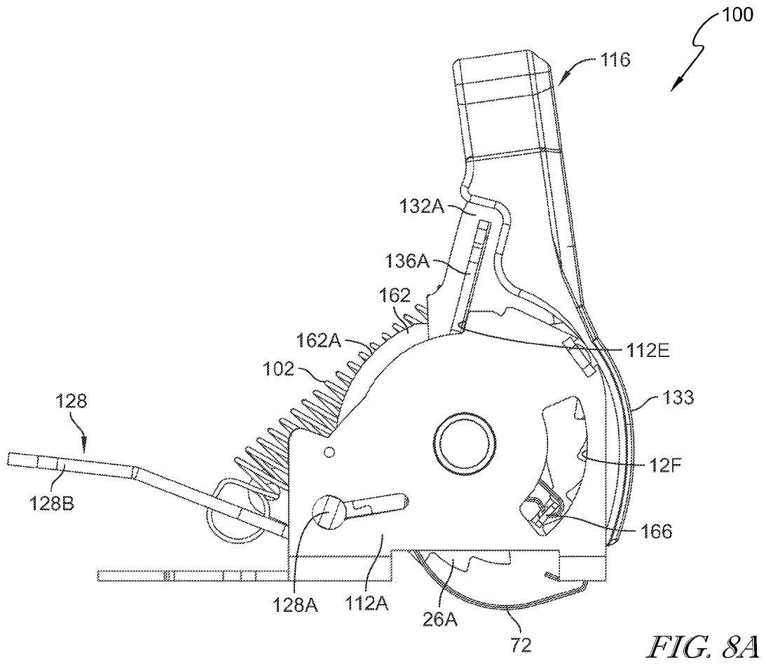

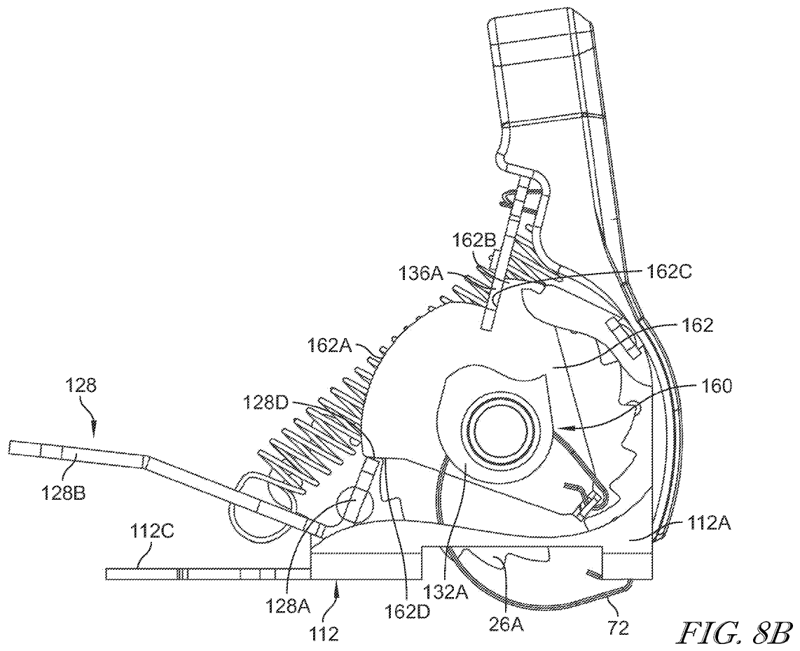

As the wings 136A, 136B of the ratchet pawl 136 reach the upper stop wall 112E of the side walls 112A, 112B of the frame 112, as shown by example in FIG. 8A, the web retractor 100 transitions to the locked mode in which the non-toothed portion 162A of the web tension limiter gear or wheel 162 has rotated sufficiently to cause the step 162D of the web tension limiter gear or wheel 162 to clear the lock bar 128A of the lock pawl 128. As depicted by example in FIG. 8B, the tension on the spring 102 from the rotation of the ratchet handle 116 forces the lock bar 128A of the lock pawl 128 to rotate toward the toothed gears or wheels until the top engaging edges 128D of the lock bar 128A engage the toothed gears or wheels 26A, 26B, thereby preventing the spool 24 from rotating in the web pay out direction. The elongated biasing member 72 causes the web tension gear or wheel 162 to rotate toward the lock bar 128A, thus causing the step 162D to engage the top engaging edge 128D of the lock bar 128A and preventing the web tension limiter gear or wheel 162 from rotating, under bias of the biasing member 72, back to the free spool position illustrated in FIGS. 7A-7D. In the locked mode, the non-toothed portion 162A of the web tension limiter gear or wheel 162 prevents the wings 136A, 136B of the ratchet pawl 136 from engaging the toothed gears or wheels 26A, 26B, thus preventing the further tension to be applied to the web 18 by operation of the ratchet handle 116.

The web retractor 100 can be manually returned from the locked mode to the free spool mode by pressing on the surface 128C of the actuating tab 128B of the lock pawl 128 with sufficient force to disengage the lock bar 128A from the toothed gears or wheels 26A, 26B and from the step 162D of the web tension limiter gear or wheel 162. The force of the biasing member 72 then causes the web tension limiter gear or wheel 162 to rotate in the web pay out direction back to the free spool position illustrated in FIGS. 7A-7D.

According to one example method of securing cargo using the retractor 10 or the retractor 100, the retractor 10 or 100, secured to a suitable structure, is manually set to the free-spooling operating mode. With the retractor 10, this is accomplished by moving the handle 16 upwardly to locate the end 37A of the ratchet pawl 36 in the notch 50, and with the retractor 100 a downward force is applied to the top surface 128C of the actuating tab 128B as described above. The web 18 is then drawn out of the retractor 10, 100 and over the cargo, and the engagement member 20 is attached to the cargo or to a suitable structure, and the retractor 10, 100 is then manually set to the web ratcheting or tensioning mode. With the retractor 10, this is accomplished by moving the handle 16 downwardly to locate the end 37A of the ratchet pawl 36 on the arcuate region 48 of the side wall 12A adjacent to the protrusion 44, and with the retractor 100 this is accomplished simply my moving the ratchet handle 116 relative to the frame 112 to engage the tooth 162B of the web tension limiting gear or wheel 162 as described above. The retractor 10, 100 is then manually ratcheted to apply tension to the engaged web 18. This is accomplished with the retractor 10 and the retractor 100 by forcing the handle 16, 116 upwardly such that the ratchet pawl 36, 136 moves along the arcuate region of the side walls of the frame 12, 112 toward the stop 46, 112E. It should be noted that with the retractor 100, the steps of manually setting the retractor 100 to the ratcheting mode and then manually ratcheted can be a single motion, whereas with the retractor 10 the handle 16 must first be drawn downwardly from the notch 50 to the protrusion 44 and then drawn upwardly toward the stop 46. In any case, with the web tension limiter 60, 160 in the web rotation prevention position, the cargo is restrained. The cargo may be freed by manually setting the retractor 10, 100 to the free-spooling mode described above to release the tension on the web 18, and the engagement member 20 may then be freed such that the web 18 is taken up on the spool 24 under bias of the power spring assembly 35.

In the embodiments of the ratcheting web retractors 10, 100 illustrated in FIGS. 1-10 and described above, the power spring assembly 35 is mounted to the outer surface of the sidewall 12B, 112B of the frame 12, 112 (see, e.g., FIGS. 4B and 4D), and is configured in a conventional manner to engage the end 14B of the shaft 14, and/or a portion of the shaft 14 adjacent to the end 14B, and bias the shaft 14 and spool 24 to rotate in the web take-up direction as described above. In embodiments in which the end 14A of the shaft 14 extends beyond the outer surface of the sidewall 12A, 112A of the frame 12, 112, as illustrated by example in FIG. 1, the total, overall width of the body of the web retractor 10, 100 is defined by the sum of the distance between the outer surfaces of the sidewalls 12A, 12B or 112A, 112B of the frame 12, 112, the width of the power spring assembly 35 and the axial length of the portion of the shaft 14 extending outwardly away from the outer surface of the sidewall 12A, 112A. In other embodiments, in which the end 14A of the shaft 14 does not extend beyond the outer surface of the wall 12A, 112A of the frame 12, 112, the total, overall width of the body of the web retractor 10, 100 is defined by the sum of the distance between the outer surfaces of the sidewalls 12A, 12B or 112A, 112B of the frame 12, 112 and width of the power spring assembly 35.

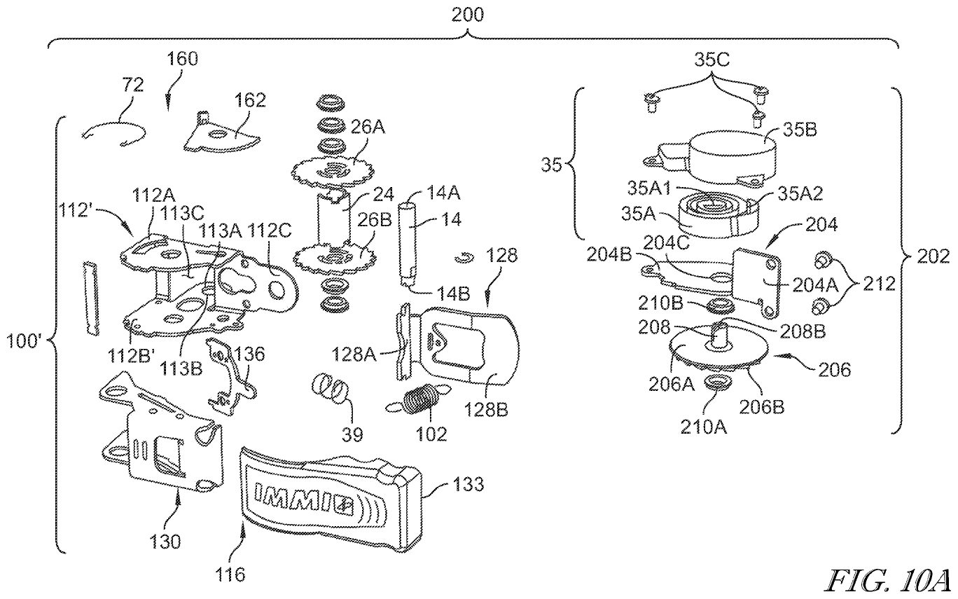

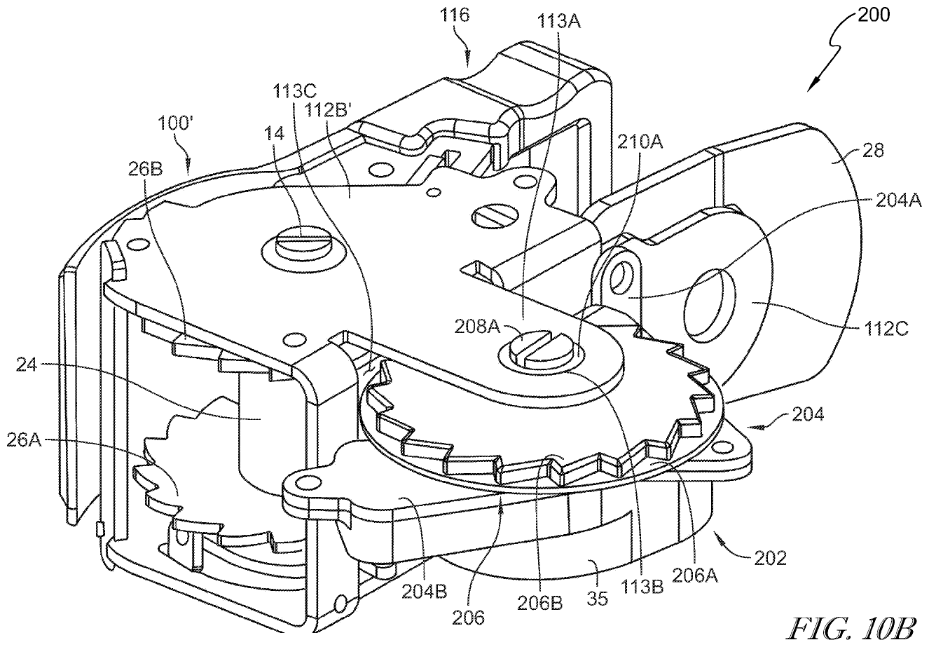

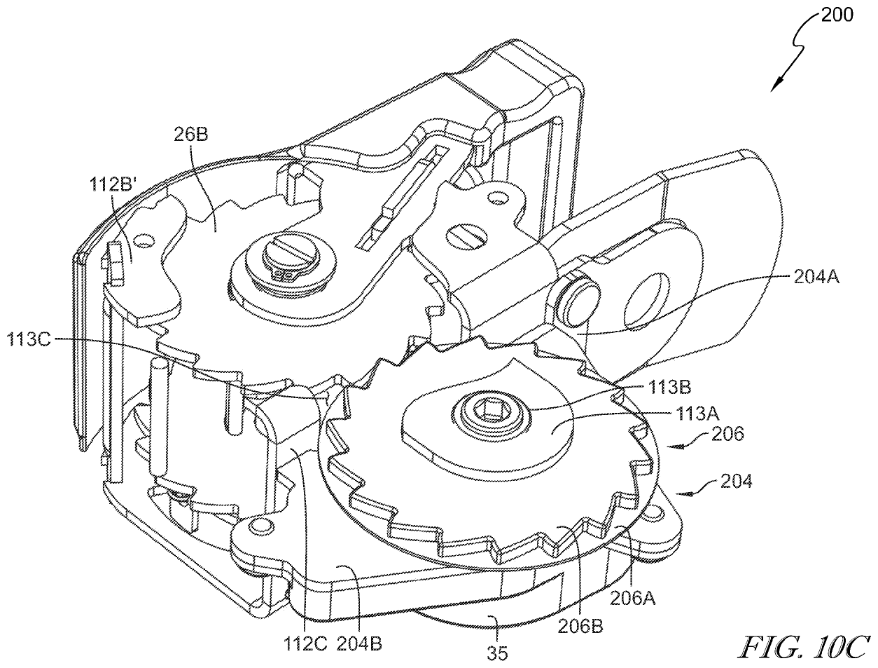

In some applications of the ratcheting web retractor 10, 100, it may be desirable to limit the overall width of the web retractor to the axial length of the shaft 14 in embodiments in which the ends 14A, 14B of the shaft extend beyond the outer (external) surfaces of the sidewalls 12A, 12B or 112A, 112B of the frame 12, 112, to the total distance between the outer surface of the sidewall 12A, 12B or 112A, 112B and the opposite end 14A, 14B of the shaft 14 in alternate embodiments in which only one end 14A, 14B of the shaft 14 extends beyond the respective sidewall 12A, 12B or 112A, 112B, or to the total distance between the outer surfaces of the sidewalls 12A, 12B or 112A, 112B of the frame 12, 112 in still other embodiments in which neither end 14A, 14B of the shaft 14 extends beyond the outer surface of the respective sidewall 12A, 12B or 112A, 112B of the frame 12, 112. One such embodiment of a ratcheting web retractor 200, in which the total, overall width of the body of the web retractor is so limited, is illustrated by example in FIGS. 10A-10C which includes a ratcheting web retractor 100′ and a power spring arrangement 202 operatively coupled thereto.

In the embodiment illustrated in FIGS. 10A-10C, the ratcheting web retractor 100′ illustratively includes the same components as the web retractor 100, and like numbers are therefore used to identify like components illustrated in FIGS. 7A-9 and described in detail above. The various operational modes of the web retractor 100′, and the structure and operation of the web tension limiter 160, are as described above with respect to the web retractor 100 of FIGS. 7A-9. The ratcheting web retractor 100′ illustratively differs from the ratcheting web retractor 100 in that the sidewall 112B of the frame 112′ of FIGS. 7A-9 is modified as described below to form a modified sidewall 112B′ and the power spring assembly 35 is relocated to, and as part of, the power spring arrangement 202. In alternate embodiments, the ratcheting web retractor 10 may be similarly modified to incorporate and include the power spring arrangement 202 described below, and in such embodiments the various operational modes of the web retractor 10, and the structure and operation of the web tension limiter 60, will be as described above with respect to FIGS. 1-6B. In either case, the total width of the body of the ratcheting web retractor 200 illustrated in FIGS. 10A-10C is defined by the axial length of the shaft 14. In alternate embodiments of the ratcheting web retractor 200 in which only one end 14A, 14B of the shaft 14 extends beyond the respective sidewall 112A, 112B′, the total width of the body of the ratcheting web retractor 200 will be defined by the distance between the protruding end 14A, 14B of the shaft 14 and the outer surface of the opposite sidewall 112A, 112B′ of the frame 112′. In still other alternate embodiments of the ratcheting web retractor 200 in which neither end 14A, 14B of the shaft 14 extends beyond the respective sidewall 112A, 112B′, the total width of the body of the ratcheting web retractor 200 will be defined by the distance between the outer surfaces of the sidewalls 112A, 112B′ of the frame 112′.

As used herein, the phrase “the body of the ratcheting web retractor” should be understood to include all of the components of the respective ratcheting web retractor 10, 100, 200 except for the handle grip 33, 133 and top frame member 32C of the handle frame 30, 130. In the embodiment illustrated in FIGS. 10A-10C and described below, the widths of the frame member 32C and the handle grip 33, 133 are both less than that of the total width of the body of the ratcheting web retractor 200, and in this embodiment the total width of the ratcheting web retractor 200 is thus the width of the body of the ratcheting web retractor 200. It will be understood, however, that in alternate embodiments the width of the frame member 32C and/or the width of the handle grip 33, 133 may be greater than the width of the body of the ratcheting web retractor 200.

In the embodiment illustrated in FIGS. 10A-10C, the bottom portion of the sidewall 112B′ of the frame 112′ is extended below the bottom wall 12C of the frame 112′ to form a lobe 113A. Illustratively, the lobe 113A is co-planar with the sidewall 112B′. In the illustrated embodiment the sidewall 112B′ and the lobe 113A are of uniform construction, although in alternate embodiments the lobe 113A may be separate from, but attached to, the sidewall 112B′. In any case, the lobe 113A defines an opening 113B therethrough adjacent to the terminal end of the lobe 113A such that the opening 113B is spaced apart from, and aligned with, the opening in the sidewall 112B′ through which the shaft 14 extends. Between the lobe 113A and the terminal end of the side wall 112A of the frame 112′, the bottom wall 112C defines an open section 113C.

A bracket 204 is configured to be mounted to the underside of the bottom wall 112C of the frame 112′ and is also configured to mount the power spring assembly 35 thereto. In the illustrated embodiment, the bracket 204 includes a planar frame wall 204A configured to be mounted to the planar underside of the bottom wall 112C of the frame 112′ via a number of conventional fixation members 212, e.g., screws, bolts, rivets or the like. Another planar wall 204B is coupled to the planar wall 204A and defines an opening 204C therethrough. The planar walls 204A, 204B each illustratively define planes that are orthogonal with one another. In one embodiment, the walls 204A, 204B are of uniform construction, although in alternate embodiments the walls 204A, 204B of the bracket 204 may be separate from but attached to one another. In any case, the bracket 204 is configured such that, with the wall 204A attached to the underside of the bottom wall 112C of the frame 112′, the opening 204C defined through the wall 204B is axially aligned with the opening 113B defined through the lobe 113A of the frame 112′.

One end 208A of a shaft 208 is configured to extend into the opening 113B defined through the lobe 113A of the sidewall 112B′ of the frame 112′, and an opposite end 208B of the shaft 208 is configured to extend into the opening 204C defined through the wall 204B of the bracket 204 such that, with the wall 204A attached to the underside of the bottom wall 112C of the frame 112′, the shaft 208 rotates within the openings 204C, 113B and relative to the wall 204B and the lobe 113A respectively. End caps 210A, 210B illustratively mount the shaft 208 to the lobe 113A and to the wall 204B such that the shaft 208 is rotatable relative to the wall 204B and the lobe 113A. A toothed gear 206 is non-rotatably mounted to the shaft 208 such that the toothed gear 206 rotates with the shaft 208 relative to the wall 204B and the lobe 113A. The toothed gear 206 illustratively includes a concentric plate 206A and a toothed wheel 206B each received on the shaft 208 with the plate 206A and the wheel 206B on contact with one another. The toothed gear 206 is sized such that, with the toothed gear 206 rotatably mounted to and between the lobe 113A and the wall 204B of the bracket 204, and with the bracket 204 mounted to the outer surface of the bottom wall 112C of the frame, at least a portion of the toothed gear 206 extends through the open section 113C of the frame 112′ and into operative engagement with the toothed wheel 26A fixed to the spool 24 and rotatably mounted to the frame 112′ within the space defined between the side walls 112A, 112B′ and the inner surface(s) of the bottom wall 112C.

A plurality of teeth are defined on and about the toothed wheel 206B, and are configured to engage, i.e., mesh with or interdigitate with, the teeth defined on and about the toothed wheel 26B mounted to the spool 24. The openings 113B and 204C are illustratively aligned with the openings in the sidewalls 112A, 112B′ of the frame 112′ such that the shafts 14, 208 each rotate about an axis that is parallel with the other, and such that toothed wheels 24 and 206B align and engage with one another through the open section 113C of the bottom wall 112C of the frame 112′. As best seen in FIG. 10C the teeth of the toothed wheel 206B are illustratively oriented in the opposite direction from the orientation of the teeth defined on and about the toothed wheel 26B mounted to the spool 24 such that the each of the toothed wheels 24 and 206B may drive the other.

The power spring assembly 35 is illustratively conventional and includes a conventional coiled power spring 35A having one end 35A1 configured to engage and couple to the end 208B of the shaft 208, and an opposite end 35A2 configured to engage and couple to a cap or housing 35B. A plurality of conventional fixation members 35C, e.g., screws or bolts or the like, attach the cap or housing 35B to the wall 204B of the bracket 204 with the power spring 35A operatively positioned therebetween as just described.

In operation, the coiled spring 35A of the power spring assembly 35 illustratively exerts a biasing force on the shaft 208 which biases the toothed gear 206 to rotate in a direction which, when transferred through the interdigitated teeth of the toothed wheels 206B and 26B, biases the spool 24, and thus the shaft 14, to rotate in the web take-up direction. To draw web 18 from the retractor 200, sufficient force must be applied, e.g., manually, to the web 18 in the web payout direction, i.e., out of and away from the retractor 200, to cause the toothed wheel 26B to rotate in the web payout direction with a rotational force which, when transferred through the teeth of the toothed wheel 26B to the teeth of the toothed wheel 206B of the toothed gear 206, causes the toothed gear 206 to overcome the biasing force of the coiled spring 35B of the power spring assembly 35 so as to pay out web 18 from the retractor 200.

In the illustrated embodiment, the toothed wheel 206B is illustratively identical, i.e., in diameter and in the number of teeth, to the toothed wheel 26B coupled to the spool 24 such that the rotational force applied by the coiled power spring 35B to the toothed wheel 206B and transferred by the toothed wheel 206B to the toothed wheel 26B is the same as that applied by the power spring assembly 35 directly to the shaft 14 in the embodiments 10, 100 illustrated in FIGS. 1-9. In alternate embodiments, the diameter and/or number of teeth of the toothed wheel 206B may be different than the diameter and/or number of teeth of the toothed wheel 26B so as to provide for some amount of rotation multiplication or reduction between the toothed wheels 206B, 26B, e.g., such that rotation of the toothed gear or wheel 206B causes the gear or wheel 26B to rotate by a greater or lesser degree of rotation than that of the gear or wheel 206B and vice versa. In some alternate embodiments, the gears or wheels 26B, 206B may be configured to rotationally drive one another by one or more conventional structures other than the meshing of teeth as depicted by example in FIGS. 10B and 10C. As one non-limiting example, the wheel or gear 206B and/or the gear or wheel 26B may be configured, or fitted, to accommodate and be coupled together by a drive belt, cord, web, tether or the like, wherein the gears or wheels 26B, 206B rotationally drive one another via the drive belt, cord, web, tether or the like coupled to and between one another. An illustrative example of a toothed drive belt of such an arrangement, which should not be considered to be limiting in any way, can be found in U.S. Pat. No. 11,370,388, issued Jun. 28, 2022, the disclosure of which is incorporated herein by reference in its entirety. Other examples will occur to those skilled in the art, and it will be understood that any such other structures and/or techniques for causing the gears or wheels 26B, 206B to rotational drive one another as described above are intended to fall within the scope of the claims appended hereto.

In any case, the bracket 204, the toothed gear 206 and the power spring assembly 35 together illustratively have a combined width that is less than the distance between the outer surfaces of the side walls 112A, 112B′ of the frame 112′ such that the combination of the frame 204, toothed gear 206 and power spring assembly 35 coupled to the bottom wall 112C resides in-board of the outer (external) surfaces of the side-walls 112A, 112B′ of the frame 112′. The total width of the power spring arrangement 202 will therefore be no greater than a total width of the frame 112′ defined between external surfaces of the side walls 112A, 112B′ or defined as a combination of a length of the shaft 14 and the total width of the frame 112′. In any case, the total width of the body of the ratcheting web retractor 200 is thus reduced by the width of the power spring assembly 35 as compared with a web retractor with a power spring assembly 35 conventionally mounted to one of the side walls 12A, 12B or 112A, 112B of the frame 12, 112 respectively as illustrated by example in FIGS. 1-9.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected. For example, whereas the ratcheting web retractor 200 illustrated in FIGS. 10A-10C includes the releasable web tension limiter 60 or 160 illustrated in FIGS. 1-9 and described above, it will be understood that the power spring arrangement 202 may alternatively be incorporated into any otherwise conventional ratcheting web retractor which does not include the releasable web tension limiter but which may benefit in some way from the reduction in total width of the body of the ratcheting web retractor made possible by the power spring arrangement 202 as described above. As another example, whereas the power spring arrangement 202 is illustrated in FIGS. 10A-10C and described above in the context of a ratcheting web retractor, it should be understood that the power spring arrangement 202 may alternatively be incorporated into any otherwise conventional web retractor which includes a conventional power spring assembly, but which may benefit in some way from the reduction in total width of the body of the ratcheting web retractor made possible by the power spring arrangement 202 as described above. Examples of such conventional web retractors in which the power spring arrangement 202 may alternatively be implemented may be or include, but are not limited to, an automatic locking web retractor (ALR), an emergency locking retractor (ELR), or the like. As yet another example, it will be understood that any of the retractors 10, 100, 200 illustrated in the attached figures and described herein may be mounted in any orientation to or within a structure, and that some implementations may include one or more web guides, separate from, and/or integral with, the retractor 10, 100, 200, for routing of the web 18 externally to the retractor 10, 100, 200 in any direction relative to web exit end of the frame 12, 112 112′ of the retractor 10, 100, 200.

1. A web retractor, comprising:
a frame including spaced-apart side walls,
a spool rotatably mounted to and between the side walls,
a web having one end mounted to the spool, the spool rotatable relative to the side walls in a web take-up direction to wrap the web onto the spool and in a web pay-out direction to unwrap the web from the spool,
a handle movably mounted to the side walls and engageable with the spool such that, with the handle engaged with the spool, movement of the handle in a first direction relative to the side walls rotates the spool in the web take-up direction, and
a web tension limiting member configured to limit engagement of the handle with the spool so as to limit rotation of the spool by the handle in the web take-up direction to a predefined fraction of a full rotation of the spool.

2. The web retractor of claim 1, further comprising a lock pawl mounted to the side walls and configured to engage the spool and prevent the spool from rotating in the web pay-out direction while allowing the spool to rotate in the web take-up direction.

3. The web retractor of claim 2, further comprising a toothed wheel fixed to the spool such that the toothed wheel rotates with the spool,
wherein the handle includes a ratchet pawl biased into engagement with the toothed wheel such that, with the ratchet pawl engaged with the toothed wheel, movement of the handle in the first direction relative to the side walls rotates the spool in the web take-up direction.

4. The web retractor of claim 3, wherein the web tension limiting member includes a web tension limiting wheel having an outer surface defining a toothed section including at least one tooth and a non-toothed section adjacent to the toothed section,
and wherein the ratchet pawl is also biased into engagement with the at least one tooth of the web tension limiting wheel such that movement of the handle in the first direction relative to the side walls causes the web tension limiting wheel to rotate in the web take-up direction for a predefined fraction of a full rotation of the spool after which the non-toothed section of the web tension limiting wheel blocks engagement of the ratchet pawl with the toothed wheel.

5. The web retractor of claim 4, wherein the web tension limiting wheel is configured to engage the lock pawl so as to maintain the web tension limiting wheel in a position in which the web tension limiting wheel blocks engagement of the ratchet pawl with the toothed wheel.

6. The web retractor of claim 5, further comprising means for disengaging the web tension limiting wheel from the lock pawl.

7. The web retractor of claim 6, further comprising a biasing member coupled to and between the web tension limiting wheel and the frame, the biasing member configured to bias the web tension limiting wheel to a position in which the ratchet pawl is engageable with the at least one tooth of the web tension limiting wheel.

8. A web retractor, comprising:
a frame including spaced-apart side walls,
a spool rotatably mounted to and between the side walls,
a toothed wheel fixed to the spool such that the spool and toothed wheel rotate together relative to the side walls,
a web having one end mounted to the spool, the spool rotatable relative to the frame in a web take-up direction to wrap the web onto the spool and in a web pay-out direction to unwrap the web from the spool,
a handle movably mounted to the side walls,
a ratchet pawl mounted to the handle, and
a web tension limiting wheel adjacent to the toothed wheel and movable relative to the side walls, the web tension limiting wheel having an outer surface defining a toothed section including at least one tooth and a non-toothed section adjacent to the toothed section,
wherein the ratchet pawl is biased into engagement with the toothed wheel and with the at least one tooth of the web tension limiting wheel such that movement of the handle in a first direction relative to the side walls causes the spool and the web tension limiting wheel to rotate together in the web take-up direction for a predefined fraction of a full rotation of the spool after which the non-toothed section of the web tension limiting wheel blocks engagement of the ratchet pawl with the toothed wheel so as to limit rotation of the spool by the handle in the web take-up direction to the predefined fraction of the full rotation of the spool.

9. The web retractor of claim 8, further comprising a biasing member coupled to and between the web tension limiting wheel and the frame, the biasing member configured to bias the web tension limiting wheel to a position in which the ratchet pawl is engageable with the at least one tooth of the web tension limiting wheel.

10. The web retractor of claim 9, further comprising a lock pawl mounted to the side walls and configured to engage the toothed wheel and prevent the spool from rotating in the web pay-out direction while allowing the spool to rotate in the web take-up direction.

11. The web retractor of claim 10, wherein the web tension limiting wheel is configured to engage the lock pawl so as to prevent the web tension limiting wheel from rotating, under bias of the biasing member, back to a position in which the ratchet pawl is engageable with the at least one tooth of the web tension limiting wheel.

12. The web retractor of claim 11, further comprising means for disengaging the web tension limiting wheel from the lock pawl.

13.-22. (canceled)

23. A web retractor, comprising:
a frame including spaced-apart side walls,
a spool rotatably mounted to and between the side walls,
a first wheel fixed to the spool such that the spool and first wheel rotate together relative to the side walls,
a web having one end mounted to the spool, the spool rotatable relative to the frame in a web take-up direction to wrap the web onto the spool and in a web pay-out direction to unwrap the web from the spool,
a second wheel rotatably mounted to the frame and operatively coupled to the first wheel such that each of the first and second wheels is rotatably drivable by the other of the first and second wheels, and
a power spring assembly coupled to the second wheel and configured to bias the second wheel to rotate in a direction which causes the first wheel to rotate the spool in the web take-up direction.

24. The web retractor of claim 23, wherein the first wheel is a first toothed wheel, and the second wheel is a second toothed wheel having teeth meshed with teeth of the first toothed wheel such that each of the first and second toothed wheels is rotatably drivable by the other of the first and second toothed wheels,
and wherein the power spring assembly is configured to bias the second toothed wheel to rotate in the direction which, when transferred through the teeth of the second toothed wheel to the teeth of the first toothed wheel, biases the spool to rotate in the web take-up direction.

25. The web retractor of claim 23, wherein the frame includes a bottom wall coupled to and between respective ends of the spaced-apart side walls,
and wherein the second toothed wheel and the power spring assembly are both coupled to the bottom wall in-board of the side-walls.

26. The web retractor of 23, wherein the frame includes a bottom wall coupled to and between respective ends of the spaced-apart side walls such that the spool is disposed within a space of the frame bounded by the side walls and an inner surface of the bottom wall,
and wherein the web retractor further comprises a bracket mounted to an outer surface, opposite the inner surface, of the bottom wall,
and wherein the second toothed wheel and the power spring assembly are both coupled to the bottom wall in-board of the side-walls,
and wherein at least a portion of the second toothed wheel extends through an open section of the bottom wall and into engagement with the first toothed wheel.

27. The web retractor of claim 26, wherein the spool is fixed to a shaft that is rotatably mounted to and between the side walls of the frame such that the spool rotates with the shaft relative to the side walls of the frame, wherein the bracket, the second toothed wheel and the power spring assembly together define a power spring arrangement,
and wherein a total width of the power spring arrangement is no greater than a total width of the frame defined between external surfaces of the side walls or defined as a combination of a length of the shaft and the total width of the frame.

28. The web retractor of claim 23, further comprising:
a handle movably mounted to the side walls and engageable with the first wheel such that, with the handle engaged with the first wheel, movement of the handle in a first direction relative to the side walls rotates the spool in the web take-up direction, and
a web tension limiting member configured to limit engagement of the handle with the first wheel so as to limit rotation of the spool by the handle in the web take-up direction to a predefined fraction of a full rotation of the spool.

29. The web retractor of claim 28, wherein the first wheel is a first toothed wheel, and the handle includes a ratchet pawl biased into engagement with the first toothed wheel such that, with the ratchet pawl engaged with the first toothed wheel, movement of the handle in the first direction relative to the side walls rotates the spool in the web take-up direction,
and wherein the web tension limiting member includes a web tension limiting wheel having an outer surface defining a toothed section including at least one tooth and a non-toothed section adjacent to the toothed section,
and wherein the ratchet pawl is also biased into engagement with the at least one tooth of the web tension limiting wheel such that movement of the handle in the first direction relative to the side walls causes the web tension limiting wheel to rotate in the web take-up direction for a predefined fraction of a full rotation of the spool after which the non-toothed section of the web tension limiting wheel blocks engagement of the ratchet pawl with the first toothed wheel.

30. The web retractor of claim 29, further comprising a lock pawl mounted to the side walls and configured to engage the first toothed wheel and prevent the spool from rotating in the web pay-out direction while allowing the spool to rotate in the web take-up direction,
wherein the web tension limiting wheel is configured to engage the lock pawl so as to maintain the web tension limiting wheel in a position in which the web tension limiting wheel blocks engagement of the ratchet pawl with the toothed wheel.
